(19) United States
(12) Patent Application Publication
(10) Pub. No.: US 2025/0153854 A1
(43) Pub. Date: May 15, 2025

(54) ENGINE MOUNT SYSTEM FOR IMPROVED PROPELLER WHIRL STABILITY

(71) Applicant: General Electric Company, Schenectady, NY (US)

(72) Inventors: Abhishek Goverdhan, Bengaluru (IN); Abhijeet Jayshingrao Yadav, Bengaluru (IN); Andrew Bryan Cannella, Lynn, MA (US); Richa Awasthi, Bengaluru (IN); Rangasai M C, Bengaluru (IN); Pamela M. Boehm, Evendale, OH (US); Narayanan P, Bengaluru (IN); Saswati Roy, Katy, TX (US)

(21) Appl. No.: 18/441,853

(22) Filed: Feb. 14, 2024

(30) Foreign Application Priority Data
Nov. 9, 2023 (IN) 202311076594

(51) Int. Cl. B64D 27/40; F02C 7/20

(52) U.S. Cl. CPC B64D 27/40; F02C 7/20; F05D 2240/90; F05D 2260/96

(57) ABSTRACT

Active control apparatus of gas turbine engine mounts are disclosed. An example apparatus for mounting a casing of an unducted gas turbine engine to a pylon, the apparatus includes a mount system; a plurality of sensors to measure at least one parameter indicating propeller whirl stability; and a controller to tune a stiffness of the mount system depending on a function of the at least one parameter measured by the plurality of sensors, the controller to tune the stiffness of the mount system by signaling an actuator, the mount system including: a first linkage; a second linkage; a first pin; a second pin; an interface to engage with the first and second linkages, the interface to at least one of rotate or slide; and the actuator to cause the interface to engage with the first and second linkages based on the signaling from the controller.

### REFERENCE TO RELATED APPLICATION

This patent claims priority to Indian Patent Application No. 202311076594, which was filed on Nov. 9, 2023. Indian Patent Application No. 202311076594 is hereby incorporated herein by reference in their entireties. Priority to Indian Patent Application No. 202311076594 is hereby claimed.

### FIELD OF THE DISCLOSURE

This disclosure relates generally to gas turbines, and, more particularly, to control for gas turbine engine mounts.

### BACKGROUND

A gas turbine engine generally includes, in serial flow order, an inlet section, a compressor section, a combustion section, a turbine section, and an exhaust section. In operation, air enters the inlet section and flows to the compressor section where one or more axial compressors progressively compress the air until it reaches the combustion section, thereby creating combustion gases. The combustion gases flow from the combustion section through a hot gas path defined within the turbine section and then exit the turbine section via the exhaust section. A gas turbine engine produces a thrust that propels a vehicle forward, e.g., a passenger aircraft. The thrust from the engine transmits loads to a wing, fuselage, or other mount, e.g., a pylon, and, likewise, the vehicle applies equal and opposite reaction forces onto the wing, fuselage, or other mounting configuration via mounts.

### BRIEF DESCRIPTION OF THE DRAWINGS

A full and enabling disclosure of the present invention, including the best mode thereof, directed to one of ordinary skill in the art, is set forth in the specification, which makes reference to the appended Figures, in which:

FIG. 1 illustrates a cross-sectional view of an existing gas turbine engine;

FIG. 2A illustrates a front view of a first existing mount that can be used to mount the engine of FIG. 1 to a pylon;

FIG. 2B illustrates a prospective view of a second existing mount that can be used to mount the engine of FIG. 1 to a pylon;

FIG. 3 illustrates a side view of a first active mount implemented in accordance with the teachings of this disclosure;

FIG. 4A illustrates a cross-sectional side view of the first active mount system of FIG. 3 in an inactive state;

FIG. 4B illustrates a cross-sectional side view of the first active mount system of FIG. 3 in an active state;

FIG. 5A illustrates a cross-sectional side view of a first linkage for use in conjunction with the first active mount system of FIG. 3;

FIG. 5B illustrates a cross-sectional side view of a second linkage for use in conjunction with the first active mount system of FIG. 3;

FIG. 6 illustrates a side view of an actuator implemented in accordance with the teachings of this disclosure; and

FIG. 7 illustrates a second active mount system in accordance with the teachings of this disclosure.

FIG. 8 illustrates a lug used in conjunction with the second active mount system of FIG. 7.

FIG. 9 illustrates an actuator and gear mechanism used in conjunction with the second active mount system of FIG. 8.

FIG. 10 illustrates a third active mount system in accordance with the teachings of this disclosure.

FIG. 11 illustrates an isometric view of a dovetail-type sliding interface of the third active mount system of FIG. 10.

FIG. 12 illustrates a cross-sectional view of the dovetail-type sliding interface of FIG. 11.

FIG. 13 illustrates a graph of the stiffness ratio of mounts in the pitch direction versus the yaw direction.

FIG. 14 illustrates a flowchart for the active control of the various active mount systems of this disclosure.

FIG. 15A illustrates a linkage of a fourth active mount system with magnetorheological fluid in a nominal state.

FIG. 15B illustrates a linkage of a fourth active mount system with magnetorheological fluid in a nominal state.

FIG. 16 illustrates a magnetorheological fluid in a nominal state.

FIG. 17 illustrates a magnetorheological fluid in an activated state.

FIG. 18 illustrates a block diagram of an engine mounted to a pylon by a forward and an aft mount.

FIG. 19 illustrates a mount system that has a variable stiffness and a variable damping factor.

FIG. 20 illustrates an alternate mount system that has a variable stiffness and a variable damping factor.

FIG. 21 is a block diagram of an example implementation of a controller such as a Full Authority Digital Engine Control.

The figures are not to scale. In general, the same reference numbers will be used throughout the drawing(s) and accompanying written description to refer to the same or like parts.

### DETAILED DESCRIPTION

Known mounts for gas turbine engines include standalone fail-safe linkages for engine mounts that extend between the mount yoke and/or pylon and the casing of the gas turbine engine. In some examples, these existing mount systems can cause an underdamped system response due to the coupling of the pitch and yaw deflection responses when there is a small perturbation in an angle of attach of the aircraft. The underdamped system response is associated with propeller whirl instability, also known as propeller whirl flutter. Propeller whirl flutter is a phenomenon of dynamic instability that can occur in a flexibly mounted aircraft engine propeller. The dynamic instability is characterized by the aircraft engine propeller wobbling or executing a whirling motion. Examples disclosed herein include linkages and mount systems which lead to less propeller whirl instability, improved dynamics (vibrations, cabin noise, etc.) and decreased weight of the mount system. Example mounts disclosed herein include an active control engine mount system with adaptive stiffness. In some examples disclosed herein, the system includes a plurality of sensors, a controller such as a Full Authority Digital Engine Control (FADEC), linkages, at least one pin, an interface to engage with the linkages, and an actuator to cause the interface to engage with the linkages.

The terms “upstream” and “downstream” refer to the relative direction with respect to fluid flow in a fluid pathway. For example, “upstream” refers to the direction from which the fluid flows, and “downstream” refers to the direction to which the fluid flows.

Various terms are used herein to describe the orientation of features. As used herein, the orientation of features, forces and moments are described with reference to the yaw axis, pitch axis, and roll axis of the vehicle associated with the features, forces and moments. In general, the attached figures are annotated with reference to the axial direction, radial direction, and circumferential direction of the gas turbine associated with the features, forces and moments. In general, the attached figures are annotated with a set of axes including the roll axis R, the pitch axis P, and the yaw axis Y. As used herein, the terms “longitudinal,” and “axial” are used interchangeably to refer to directions parallel to the roll axis. As used herein, the term “lateral” is used to refer to directions parallel to the pitch axis. As used herein, the term “vertical” and “normal” are used interchangeably to refer to directions parallel to the yaw axis.

In some examples used herein, the term “substantially” is used to describe a relationship between two parts that is within three degrees of the stated relationship (e.g., a substantially colinear relationship is within three degrees of being linear, a substantially perpendicular relationship is within three degrees of being perpendicular, a substantially parallel relationship is within three degrees of being parallel, etc.). As used herein, the term “linkage” refers to a connection between two parts that restrain the relative motion of the two parts (e.g., restrain at least one degree of freedom of the parts, etc.). “Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

As used in this patent, stating that any part is in any way on (e.g., positioned on, located on, disposed on, or formed on, etc.) another part, indicates that the referenced part is either in contact with the other part, or that the referenced part is above the other part with one or more intermediate part(s) located therebetween. Connection references (e.g., attached, coupled, connected, joined, detached, decoupled, disconnected, separated, etc.) are to be construed broadly and may include intermediate members between a collection of elements and relative movement between elements unless otherwise indicated. As used herein, the term “decouplable” refers to the capability of two parts to be attached, connected, and/or otherwise joined and then be detached, disconnected, and/or otherwise non-destructively separated from each other (e.g., by removing one or more fasteners, removing a connecting part, etc.). As such, connection/disconnection references do not necessarily infer that two elements are directly connected and in fixed relation to each other. Stating that any part is in “contact” with another part means that there is no intermediate part between the two parts.

Descriptors “first,” “second,” “third,” etc., are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

Most gas turbine engine architectures include existing mounts with three point standalone connections on the gas turbine engine structure or frame to a pylon of an aircraft. In some examples, these mounts constrain three degrees of freedom (DOF) (e.g., lateral loads, vertical loads, and moments about the roll axis, etc.) of the coupled gas turbine engine. These engine mounts are not connected to an engine control system or controller, such as a FADEC. Additionally, the existing mount systems include linkages of constant material, constant stiffness, and a constant mount link angle. The lack of variability can lead to an underdamped system response when subjected to perturbations in flight conditions, such as an angle of attack, due to the coupling of the pitch and yaw deflection responses.

Examples disclosed herein overcome the above-referenced deficiencies via an engine mounting configuration that allows for control over the damping and stiffness of the mount system. Some of the engine mounts disclosed herein include mechanisms to actively control the stiffness of the mount system in the pitch and yaw directions. Some of the engine mounts disclosed herein include tunable damping factors for the linkages and/or mount platform. In some examples disclosed herein, the engine mounts react in three degrees of freedom between the pylon and the gas turbine engine (e.g., the rotation about the roll axis, vertical loads, lateral loads, etc.). Some of the examples disclosed herein reduce the weight of the overall mount system. Some of the examples disclosed herein reduce the vibrations and cabin noise experienced over the aircraft mission.

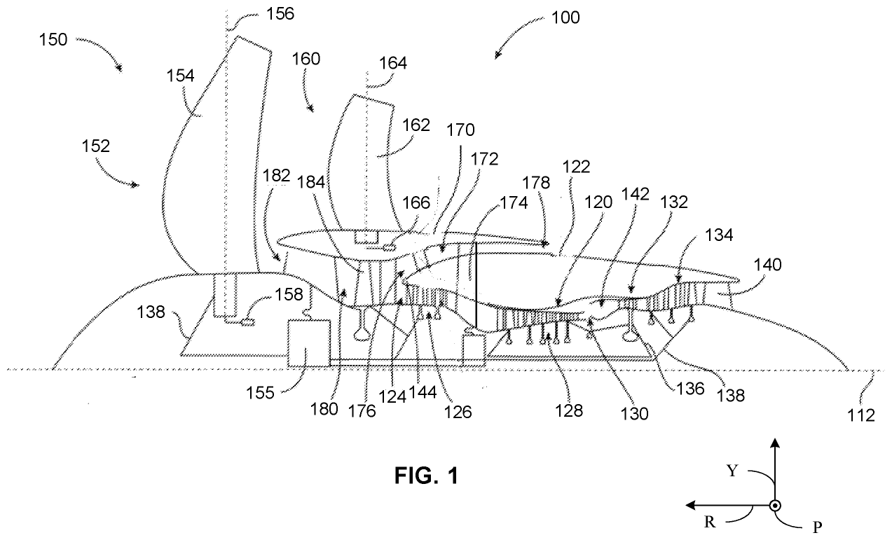

Referring now to the figures, FIG. 1 is a schematic cross-sectional view of an example gas turbine engine 100 that can be used to implement the teachings of this disclosure. The gas turbine engine 100 can be mounted to an aerial vehicle, such as a fixed-wing aircraft, and can produce thrust for propulsion of the aerial vehicle. The gas turbine engine 100 includes a fan that is not ducted by a nacelle or cowl, such that it may be referred to herein as an “unducted fan,” or the entirety of the gas turbine engine 100 may be referred to as an “unducted engine,” “an open-rotor gas turbine engine,” “an open-fan gas turbine engine,” etc.

The gas turbine engine 100 includes a core engine 120 and a fan section 150 positioned upstream thereof. Generally, the core engine 120 includes, in serial flow order, a compressor section, a combustion section, a turbine section, and an exhaust section. Particularly, as shown in FIG. 1, the core engine 120 includes a core cowl 122 that defines an annular core inlet 124. The core cowl 122 further encloses a low pressure system and a high pressure system. In certain examples, the core cowl 122 may enclose and support a booster or low pressure (“LP”) compressor 126 for pressurizing the air that enters the core engine 120 through annular core inlet 124. A high pressure (“HP”), multi-stage, axial-flow compressor 128 receives pressurized air from the LP compressor 126 and further increases the pressure of the air. The pressurized air stream flows downstream to a combustor 130 where fuel is injected into the pressurized air stream and ignited to raise the temperature and energy level of the pressurized air. It will be appreciated that as used herein, the terms “high/low speed” and “high/low pressure” are used with respect to the high pressure/high speed system and low pressure/low speed system interchangeably. Further, it will be appreciated that the terms “high” and “low” are used in this same context to distinguish the two systems and are not meant to imply any absolute speed and/or pressure values.

The high energy combustion products flow from the combustor 130 downstream to a high pressure turbine 132. The high pressure turbine 132 drives the high pressure compressor 128 through a high pressure shaft 136. In this regard, the high pressure turbine 132 is drivingly coupled with the high pressure compressor 128. The high energy combustion products then flow to a low pressure turbine 134. The low pressure turbine 134 drives the low pressure compressor 126 and components of the fan section 150 through a low pressure shaft 138. In this regard, the low pressure turbine 134 is drivingly coupled with the low pressure compressor 126 and components of the fan section 150. The LP shaft 138 is coaxial with the HP shaft 136 in this example. After driving each of the turbines 132, 134, the combustion products exit the core engine 120 through a core exhaust nozzle 140 to produce propulsive thrust. Accordingly, the core engine 120 defines a core flow path or core duct 142 that extends between the core inlet 124 and the core exhaust nozzle 140. The core duct 142 is an annular duct positioned generally inward of the core cowl 122 along the radial direction R.

The fan section 150 includes a fan 152, which is the primary fan in this example. For the depicted example of FIG. 1, the fan 152 is an open rotor or unducted fan. However, in other examples, the fan 152 may be ducted, e.g., by a fan casing or nacelle circumferentially surrounding the fan 152. While the fan 152 includes an array of fan blades 154, only one example fan blade 154 is shown in FIG. 1. The fan blades 154 are rotatable, e.g., about the longitudinal axis 112. As noted above, the fan 152 is drivingly coupled with the low pressure turbine 134 via the LP shaft 138. The fan 152 can be directly coupled with the LP shaft 138, e.g., in a direct-drive configuration. Optionally, as shown in FIG. 1, the fan 152 can be coupled with the LP shaft 138 via a speed reduction gearbox 155, e.g., in an indirect-drive or a geared-drive configuration.

Moreover, the fan blades 154 can be arranged in equal spacing around the longitudinal axis 112. Each blade 154 has a root and a tip and a span defined therebetween. Each of the fan blades 154 defines a central blade axis 156. For this example, each blade 154 of the fan 152 is rotatable about its respective central blade axes 156, e.g., in unison with one another. One or more actuators 158 can be controlled to pitch the blades 154 about their respective central blade axes 156. However, in other examples, each of the fan blades 154 may be fixed or unable to be pitched about its central blade axis 156.

The fan section 150 further includes a fan guide vane array 160 that includes fan guide vanes 162 (only one shown in FIG. 1) disposed around the longitudinal axis 112. For this example, the fan guide vanes 162 are not rotatable about the longitudinal axis 112. Each fan guide vane 162 has a root and a tip and a span defined therebetween. The fan guide vanes 162 may be unshrouded as shown in FIG. 1 or may be shrouded, e.g., by an annular shroud spaced outward from the tips of the fan guide vanes 162 along the radial direction R. Each fan guide vane 162 defines a central blade axis 164. For this example, each fan guide vane 162 of the fan guide vane array 160 is rotatable about its respective central blade axes 164, e.g., in unison with one another. One or more actuators 166 can be controlled to pitch the fan guide vane 162 about their respective central blade axes 164. However, in other examples, each fan guide vane 162 may be fixed or unable to be pitched about its central blade axis 164. The fan guide vanes 162 are mounted to a fan cowl 170.

As shown in FIG. 1, in addition to the fan 152, which is unducted, a ducted fan 184 is included aft of the fan 152, such that the gas turbine engine 100 includes both a ducted and an unducted fan that both serve to generate thrust through the movement of air without passage through core engine 120. The ducted fan 184 is shown at about the same axial location as the fan guide vane 162, and radially inward of the fan guide vane 162. Alternatively, the ducted fan 184 may be between the fan guide vane 162 and core duct 142 or be farther forward of the fan guide vane 162. The ducted fan 184 may be driven by the low pressure turbine 134 (e.g., coupled to the LP shaft 138), or by any other suitable source of rotation, and may serve as the first stage of booster or may be operated separately.

The fan cowl 170 annularly encases at least a portion of the core cowl 122 and is generally positioned outward of the core cowl 122 along the radial direction R. Particularly, a downstream section of the fan cowl 170 extends over a forward portion of the core cowl 122 to define a fan flow path or fan duct 172. Incoming air may enter through the fan duct 172 through a fan duct inlet 176 and may exit through a fan exhaust nozzle 178 to produce propulsive thrust. The fan duct 172 is an annular duct positioned generally outward of the core duct 142 along the radial direction R. A plurality of stationary struts 174 may each be aerodynamically contoured to direct air flowing thereby. Other struts in addition to the stationary struts 174 may be used to connect and support the fan cowl 170 and/or core cowl 122. In many examples, the fan duct 172 and the core cowl 122 may at least partially co-extend (generally axial direction) on opposite sides (e.g., opposite radial sides) of the core cowl 122. For example, the fan duct 172 and the core cowl 122 may each extend directly from the leading edge 144 of the core cowl 122 and may partially co-extend in a generally axial direction on opposite radial sides of the core cowl.

The gas turbine engine 100 also defines or includes an inlet duct 180. The inlet duct 180 extends between an engine inlet 182 and the core inlet 124/fan duct inlet 176. The engine inlet 182 is defined generally at the forward end of the fan cowl 170 and is positioned between the fan 152 and the fan guide vane array 160 along the axial direction A. The inlet duct 180 is an annular duct that is positioned inward of the fan cowl 170 along the radial direction R. Air flowing downstream along the inlet duct 180 is split, not necessarily evenly, into the core duct 142 and the fan duct 172 by a splitter or leading edge 144 of the core cowl 122. The inlet duct 180 is wider than the core duct 142 along the radial direction R. The inlet duct 180 is also wider than the fan duct 172 along the radial direction R.

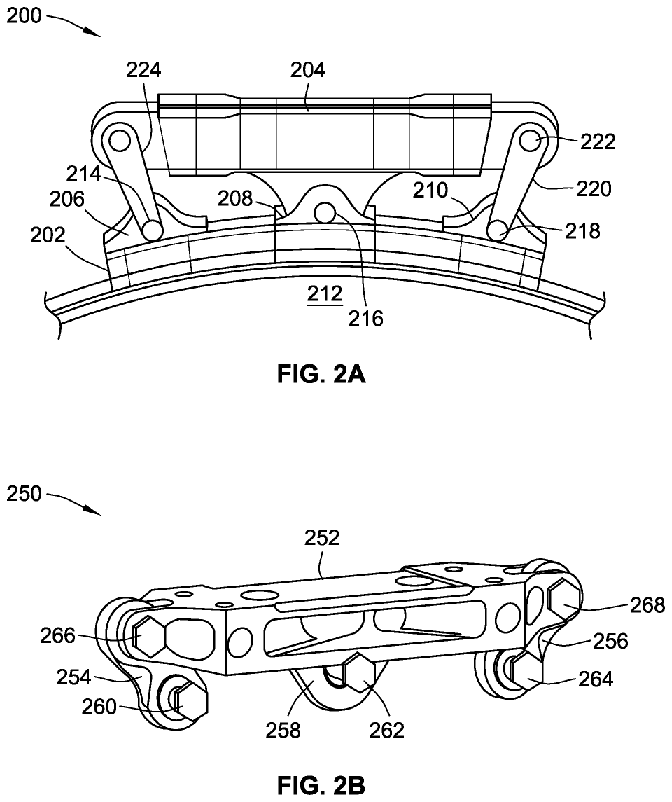

FIG. 2A illustrates a front view of an existing mount system 200 that can be used to mount an engine casing 212 to a pylon (not illustrated). In FIG. 2, the existing mount system 200 includes a mount platform 202, a mount 204, a first clevis 208, a second clevis 206, and a third clevis 210. The mount 204 is coupled to the mount platform 202 through the clevises 206, 208, 210. The mount 204 is directly coupled to the first clevis 208 and held in place by a first pin 216. The second and third clevis 206, 210 are used to indirectly couple the mount 204 to the mount platform 202 by way of linkages 220, 224. In FIG. 2A, a first linkage 220 is shown to couple the mount platform 202 to the mount 204 through the third clevis 210. The coupling includes a second pin 218 at the third clevis 210 and a third pin 222 at the mount 204. The existing mount system 200 is standalone and accordingly not connected to an engine control system or full authority digital engine control (FADEC) system.

As shown in FIG. 2A, the first, second, and third clevis mechanisms mount the engine casing to a pylon by linkages 220, 224 connected to the second clevis 206 and the third clevis 210. The linkages 220, 224 are connected to the clevises by pins 214, 218. Because the linkages in the existing mount system 200 have a constant stiffness, there is an inability to tune the stiffness or damping to propeller whirl to control the propeller wobbling or executing a whirling motion. Rather, the propeller whirl is subjected to an underdamped response by the existing mount system 200 due to coupling of the deflections in the pitch and the yaw directions.

The existing mount system 200 constrains three degrees of freedom of the coupled gas turbine engine. For example, the existing mount system 200 reacts vertical loads (a first degree of freedom), lateral loads (a second degree of freedom), and moments about the roll axis (a third degree of freedom). The existing mount system 200 can be used in conjunction with other engine mounts to fully constrain six degrees of freedom of the coupled gas turbine engine. For example, another existing mount system 200 reacts longitudinal loads (a fourth degree of freedom), moments about the pitch axis (a fifth degree of freedom), and moments about the yaw axis (a sixth degree of freedom). In some such examples, imbalances in vertical and/or lateral loads between the existing mount system 200 and the other engine mounts can be used to react pitch and/or yaw moments applied to the gas turbine engine.

FIG. 2B illustrates a prospective view of a second existing mount system 250 that can be used to mount an engine casing to a pylon (not illustrated). In FIG. 2, the second existing mount system 250 includes a mount 252, linkages 254, 256, a mounting member 258, and pins 260, 262, 264, 266, 268. The linkages 254, 256 are held in place by pins 260, 264, 266, 268. Pins 266, 268 couple the linkages 254, 256 to the mount 252 at a first end of the linkages 254, 256. At a second end of the linkages 254, 256, pins 260, 264 couple the linkages 254, 256 to clevises (not shown) on a mount platform (not shown), such as the clevises 206, 208, 210 on mount platform 202 of FIG. 2A. The second existing mount system 250 is not connected to an engine control system, such as a FADEC system.

Similar to the existing mount system 200, second existing mount system 250 utilizes linkages with a constant stiffness, causing an inability to tune the stiffness or damping to propeller whirl. Rather, the propeller whirl is subjected to an underdamped response by the mount system due to coupling of the deflections in the pitch and the yaw directions.

The second existing mount system 250 constrains three degrees of freedom of the coupled gas turbine engine. For example, the second existing mount system 250 reacts vertical loads (a first degree of freedom), lateral loads (a second degree of freedom), and moments about the roll axis (a third degree of freedom). The second existing mount system 250 can be used in conjunction with other engine mounts to fully constrain six degrees of freedom for the coupled gas turbine engine. In some such examples, imbalances in vertical and/or lateral loads between the second existing mount system 250 and the other engine mounts can be used to react pitch and/or yaw moments applied to the gas turbine engine.

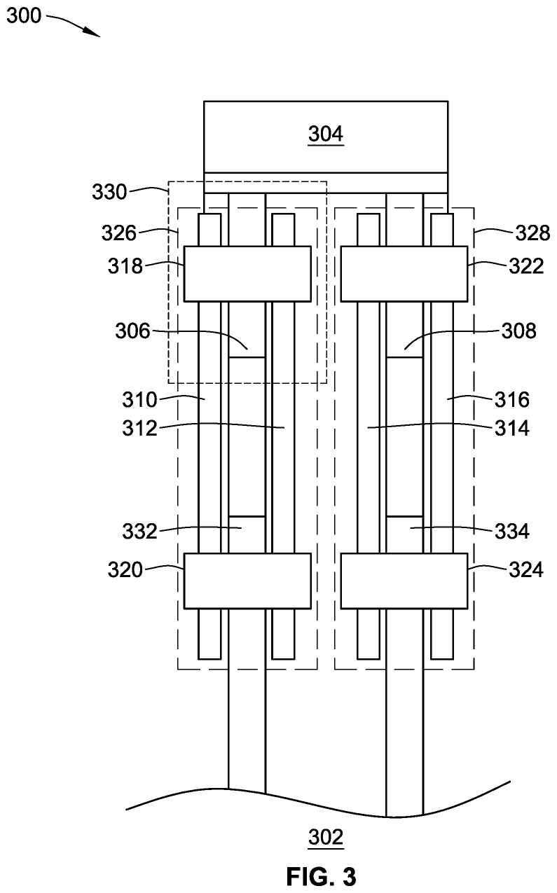

The following examples refer to gas turbine engines and mounting configurations that are similar to those described with reference to FIGS. 1-2, except that the mount system includes active control engine mount systems with adaptive stiffness. When the same element number is used in connection with FIGS. 3-20 as was used in FIGS. 1-2, the element number has the same meaning unless indicated otherwise.

FIG. 3 illustrates a side view of a first active mount system 300 implemented in accordance with the teachings of this disclosure. In the illustrated example of FIG. 3, the first active mount system 300 couples an engine casing 302 to a pylon 304. The pylon 304 couples the engine casing 302 to a wing, fuselage, or other mounting configuration of an aircraft. In the illustrated example of FIG. 3, the first active mount system 300 includes a primary load path 328 and a failsafe load path 326. In the primary load path 328, a first linkage 314 is on a first side of a first lug 308 and a second linkage 316 is on a second side of the first lug 308. A first pin 322 couples the first and second linkages 314, 316 to the first lug 308 to couple to the pylon 304, and a second pin 324 couples the first and second linkages 314, 316 to a second lug 334 to couple to the engine casing 302. In the failsafe load path 326, a third linkage 310 is on a first side of a third lug 306 and a fourth linkage 312 is on a second side of the third lug 306. A third pin 318 couples the third and fourth linkages 310, 312 to the third lug 306 to couple to the pylon 304, and a fourth pin 320 couples the third and fourth linkages 310, 312 to a fourth lug 332 to couple to the engine casing 302.

The first linkage 314, second linkage 316, third linkage 310, and fourth linkage 312 are example two-pin linkages (e.g., a swing link, etc.). The primary load path 328 includes first and second linkages 314, 316, whereas the failsafe load path 326 includes the third and fourth linkages 310, 312. The primary load path(s) 328 bears load during the normal operation of the gas turbine engine and/or pylon 304, and the failsafe load path 326 does not bear load. If the primary load path 328 no longer exists (e.g., a failure of the component of the primary load path 328, etc.), the failsafe load path(s) 326 begins to carry the load previously transferred via the primary load path 328.

The forces and moments generated by the weight and operation of the gas turbine engine associated with the engine casing 302 are reacted between and/or by the first active mount system 300 and/or the other mounts of a gas turbine engine (e.g., a gas turbine engine similar to the gas turbine engine 100 of FIG. 1, etc.). In the illustrated example of FIG. 3, the first active mount system 300 constrains three degrees of freedom of the coupled gas turbine engine by reacting vertical loads, lateral loads, and moments about the roll axis. In some such examples, imbalances in vertical and/or lateral loads between the first active mount system 300 and the other engine mounts can be used to react pitch and/or yaw moments applied to the gas turbine engine. These other mounts can include thrust links, front mounts and/or any other suitable connections between the gas turbine engine and the pylon 304. The example first active mount system 300 of FIG. 3 may be implemented to couple the engine casing 302 to the pylon 304 in a first direction or a second direction to react the loads and moments experienced in three degrees of freedom. In some examples, multiple first active mount systems 300 may be used in both a first direction and a second direction to react the loads and moments in six degrees of freedom.

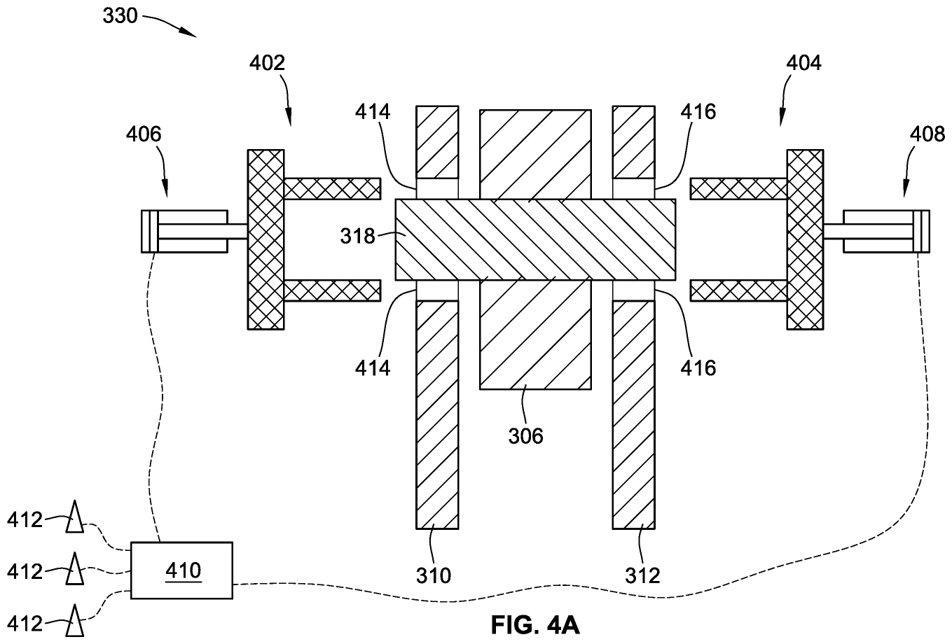

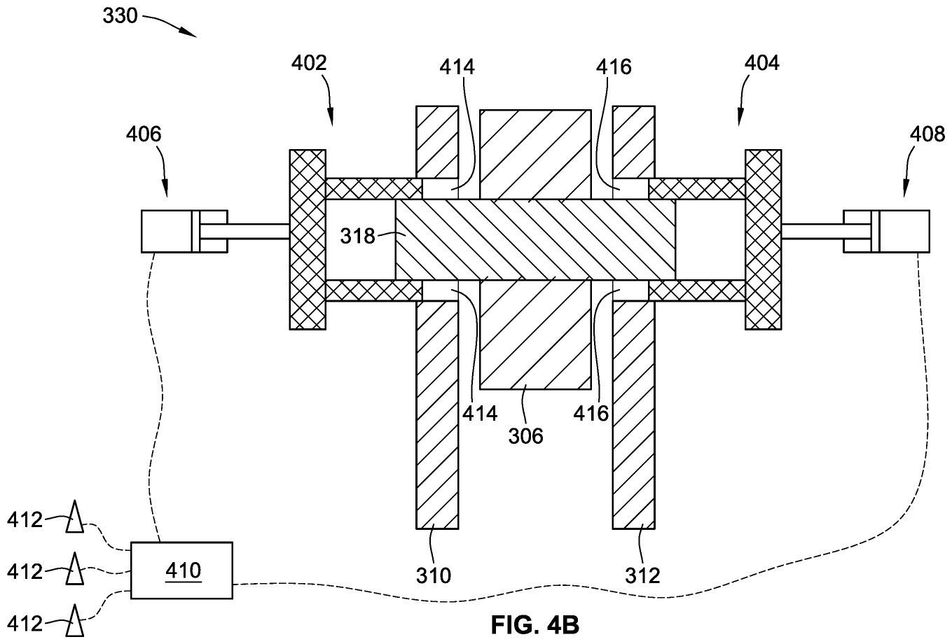

In FIG. 3, the failsafe load path 326 includes an example first active mount 330 of the first active mount system 300. The first active mount 330 is described in further detail in connection with FIG. 4. The first active mount 330 can be activated based on detection of propeller whirl. The first active mount 330 has a response (e.g., activated or deactivated) so that, when activated, the failsafe load path 326 is engaged to couple the third pin 318 to the third lug 306, and, in doing so, couples the third and fourth linkages 310, 312 to the third lug 306. Effectively, the engine casing 302 is coupled to the pylon 304 by the failsafe load path 326. In some examples, the failsafe load path 326 has a greater stiffness than the stiffness of the primary load path 328. In other examples, the failsafe load path 326 has a stiffness equal to the stiffness of the primary load path 328. The stiffness of the failsafe load path 326 is additive or reinforcing so that the overall stiffness of the first active mount system 300 is greater than when the primary load path 328 is isolated.

FIG. 4A is a cross-sectional view of the first active mount 330 of FIG. 3 in an inactive state. In the illustrated example of FIG. 4A, the first active mount 330 includes lug 306 with third linkage 310 having a first slot 414 on a first side, and fourth linkage 312 having a second slot 416 on a second side. An interface such as a first sliding sleeve 402, a second interface such as a second sliding sleeve 404, a first actuator 406, and a second actuator 408 are also included in the first active mount 330 of FIG. 4A.

In the first active mount system 330 of FIG. 4A, the third pin 318 is inserted through the lug 306. The first linkage 310 is aligned on a first side of the lug 306 to align a first end of the third pin 318 through the first slot 414. The second linkage 312 is aligned on a second side of the lug 306 to align a second end of the third pin 318 through the second slot 416. The first sliding sleeve 402 is aligned to insert into the first slot 414 of the first linkage 310 to couple the first linkage 310 to the third pin 318. The first actuator 406 is coupled to the first sliding sleeve 402 to actuate the first sliding sleeve 402 to insert into the first slot 414 of the first linkage 310. The second sliding sleeve 404 is aligned to insert into the second slot 416 of the second linkage 312 to couple the second linkage 312 to the third pin 318. The second actuator 408 is coupled to the second sliding sleeve 404 to actuate the second sliding sleeve 404 to insert into the second slot 416 of the second linkage 312. The first actuator 406 and the second actuator 408 are connected to the FADEC 410.

In operation, the FADEC 410 dictates the actuation of the first actuator 406 and the second actuator 408 between an inactive state of the first active mount 330 (shown in FIG. 4A) and an active state of the first active mount 330 (shown in FIG. 4B). The FADEC 410 measures parameters indicative of propeller whirl through the plurality of sensors 412. When a threshold associated with propeller whirl is achieved, the FADEC 410 determines the stiffness of the mount system 300 of FIG. 3 needs to be adjusted. The FADEC 410 sends a signal to the first actuator 406 and the second actuator 408 to actuate from the inactive state to the active state. The actuation of the first actuator 406 and the second actuator 408 inserts the first sliding sleeve 402 and the second sliding sleeve 404 into the first slot 414 and the second slot 416, respectively.

In some examples, the inactive state of the first active mount 330 works in operation as a failsafe load path 326. In other words, the primary load path 328 is load bearing, and the first active mount 330 operates when the primary load path 328 is no longer engaged or when propeller whirl is detected. In such an example, the FADEC 410 causes first and second actuators 406, 408 to activate. An example of the first active mount 330 in an activated state is shown in FIG. 4B.

In FIG. 4B, the first active mount 330 of FIGS. 3 and 4A is shown in the active state. The first active mount 330 of FIGS. 3 and 4A includes the third linkage 310 having the first slot 414, the fourth linkage 312 having the second slot 416, the third lug 306 positioned in between the linkages 310, 312, the third pin 318 to cause the linkages 310, 312 to engage with the lug 306, sliding sleeves 402, 404 to cause the linkages 310, 312 to engage with the third pin 318, and actuators 406, 408 to actuate the sliding sleeves 402, 404 and transition the sliding sleeves 402, 404 from an inactive state to an active state or from an active state to an inactive state.

As shown in FIG. 4B, the first active mount 330 is activated. For example, the FADEC 410 has detected propeller whirl, triggering engagement of the first active mount 330. In other examples, the primary load path 328 of FIG. 3 fails, and, subsequently, the FADEC 410 causes the failsafe load path 326 to activate. Once activated, the actuators 406, 408 extend into an activated state, which causes the sliding sleeves 402, 404 to push into the first and second slots 414, 416 in the linkages 310, 312. By being inserted in the slots 414, 416 in the linkages 310, 312, the sliding sleeves 402, 404 couple the linkages 310, 312 to the third pin 318 and the third lug 306. The coupling of the linkages 310, 312 to the third pin 318 and the third lug 306 effectively activates the failsafe load path 326, creating a load bearing path. The load bearing path has a stiffness associated with the path. In some examples such as that by which the FADEC 410 has detected propeller whirl, the stiffness of the failsafe load path 326 is added to the primary load path 328. In other examples in which the FADEC 410 has detected a primary load path 328 failure, the failsafe load path 326 acts as a failsafe when the FADEC 410 activates the actuators 406, 408 to engage the sliding sleeves 402, 404 into the slots 414, 416 to couple the third pin 318 to the linkages 310, 312. The engagement of the components creates a load bearing path that bears load in the presence of failure of the primary load path 328.

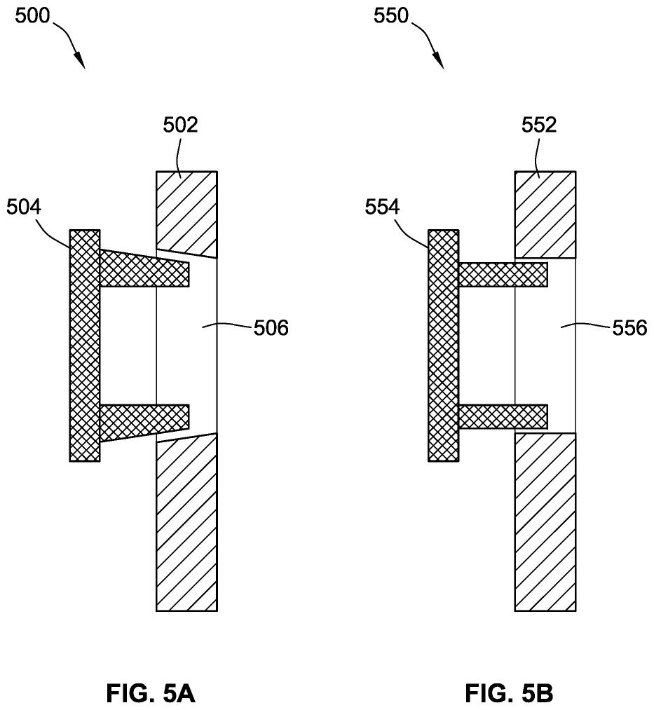

FIGS. 5A and 5B demonstrate example linkages for use with the first active mount 330 of FIGS. 3, 4A, and 4B. A tapered mount system 500 FIG. 5A includes a tapered slot linkage 502, herein also referred to as “mount link 502”, with a tapered slot 506 for use with an interface which is tapered, such as a tapered sliding sleeve 504. As an alternative, a level mount system 550 of FIG. 5B includes a level slot linkage 552, herein also referred to as “mount link 552”, with a level slot 556 and a level sliding sleeve 554. Each configuration actively mounts the mount system 500, 550 and engages mount links 502, 552 when propeller whirl is sensed in the engine, adding another link element in the overall mount system. The addition of the mount links 502, 552 increases the system stiffness to help avoid resonance and whirl instability. FIG. 5A demonstrates the tapered mount system 500 which accounts for part tolerances and enables easier engagement into tapered slot 506 than a level system with 90-degree angles. As an alternative, the level mount system 550 has a more rigid engagement due to the 90-degree angles between the level slot 556 and the body of the level slot linkage 552. Both configurations shown in FIGS. 5A and 5B have inactive and active states similar to those described in connection with FIGS. 4A and 4B.

In operation, the active state of the failsafe load path 326 of FIG. 3 is engaged when propeller whirl is detected or when the primary load path 328 of FIG. 3 is no longer engaged. The failsafe load path 326 can be engaged or disengaged. Accordingly, the stiffness of the mount system is adjustable by having a stiffness associated with the primary load path 328, a stiffness associated with the primary load path 328 and the failsafe load path 326, or a stiffness associated with the failsafe load path 326. The active state is triggered by the FADEC 410 of FIGS. 4A and 4B. In some examples, the FADEC 410 is connected to a plurality of sensors 412 of FIGS. 4A and 4B to measure at least one parameter indicating propeller whirl stability (e.g., mount vibration, conditional monitoring vibration, flow parameters, thrust, torque, angle of attack, etc.). The data measured from the sensors 412 is leveraged to determine the engine response and detect propeller whirl in real-time. In some examples, control logic is implemented by the FADEC 410 based on the data from the sensors 412 to determine the onset of propeller whirl and the level of activation needed in the mounts to mitigate the propeller whirl until the whirl subsides or until the range of activation is exceeded.

In the mechanism of FIGS. 5A and 5B when propeller whirl is detected, the FADEC 410 sends a signal to the actuators 406, 408 of FIGS. 4A and 4B to actuate and cause the sliding sleeves 504, 554 to move towards the slots 506, 556 in the mount links 502, 552, respectively. The sliding sleeves 504, 554 fill the slots 506, 556 in the mount links 502, 552, causing a coupling from the mount links 502, 552 through a pin to a lug (e.g., the pin 318 and the lug 306 of FIGS. 4A and 4B). This coupling effectively causes the failsafe load path 326 to become active and bear load. In some examples, the mount links 502, 552 are made using different parameters (e.g., material, thickness, width, length, etc.) in order to ensure that the failsafe load path 326 has a higher stiffness than the stiffness associated with the primary load path 328. In other examples, the parameters of the mount links 502, 552 are the same as the linkages in the primary load path 328 to create an additive effect of the stiffness associated with the first active mount system 300.

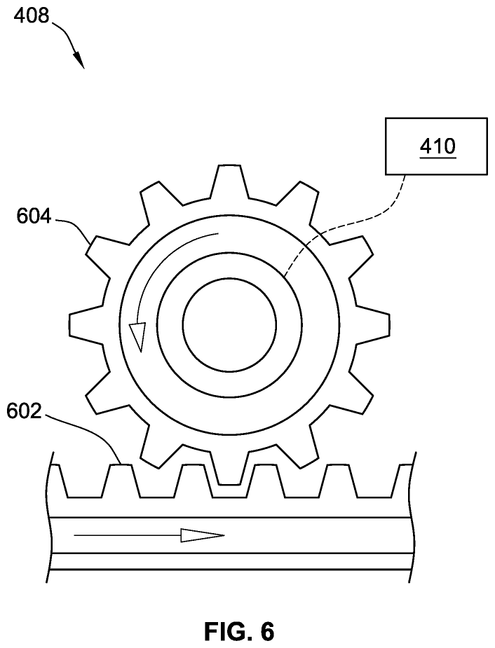

FIG. 6 illustrates a side view of the actuator 408. The example actuator 408 shown is a rack and pinion actuator that includes a rack 602 and a pinion 604, with the pinion 604 connected to the FADEC 410. In other examples, the example actuator 408 may be a hydraulic actuator, a piezoelectric actuator, a spring actuator, a shape memory alloy actuator, or other type of actuator.

In operation, the FADEC 410 sends an electric signal to the actuator 408 to cause movement between the activated state and deactivated state of FIGS. 4B and 4A, respectively. In the example of FIG. 6, the electric signal is sent by the FADEC 410 to the pinion 604 to cause the pinion 604 to rotate in a counter-clockwise direction as shown in FIG. 6. Rotation of the pinion 604 in a counter-clockwise direction causes the rack 602 to extend due to coupling of the teeth on both the pinion 604 and rack 602. Once fully extended, the FADEC 410 stops sending the electric signal to halt the rotation of the pinion 604, leaving the actuator 408 in an activated state. When the FADEC 410 determines that the first active mount 330 of FIGS. 3, 4A, and 4B needs to be in a deactivated state, the FADEC 410 sends an electric signal to cause the pinion 604 to rotate in a clockwise direction to retract the rack 602 due to the coupling of the teeth.

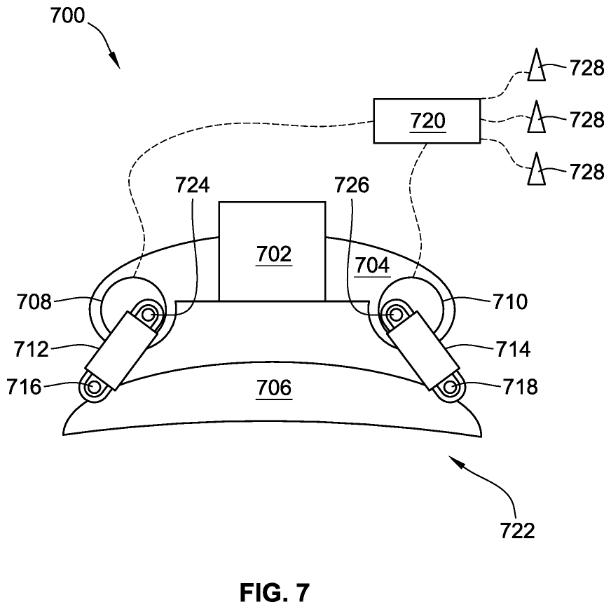

FIG. 7 demonstrates a second active mount system 700. The second active mount system includes a pylon 702, a mount 704, an engine casing 706, an interface such as a first rotating lug 708, a second interface such as a second rotating lug 710, a first linkage 712, a second linkage 714, a first pin 716, a second pin 724, a third pin 718, a fourth pin 726, a FADEC 720, and a plurality of sensors 728. The engine casing 706 is connected to the mount 704 and the pylon 702 through the coupling of the linkages 712, 714 by the pins 716, 718, 724, 726.

In operation of the example of FIG. 7, the FADEC 720 detects propeller whirl using sensors 728 to measure parameters such as mount vibration, conditional monitoring vibration, flow parameters, thrust, torque, angle of attack, etc. The FADEC 720 collects the sensed parameter data and detects propeller whirl through a function assessing whether the parameter data exceed a pre-defined propeller whirl threshold. In this example, the FADEC 720 then adjusts the angular position of the first and second rotating lugs 708, 710. In changing the position of the first and second rotating lugs 708, 710, the linkages 712, 714 change angles with respect to the engine casing 706. The change in angles changes the stiffness of the second active mount system 700 by changing the forces each linkage 712, 714 experiences in the mount and yaw directions. By changing the angles of the linkages 712, 714, the second active mount system 700 improves stability when an aircraft is experiencing propeller whirl.

The forces and moments generated by the weight and operation of the gas turbine engine associated with the engine casing 706 are reacted between and/or by the second active mount system 700 and/or the other mounts of a gas turbine engine (e.g., a gas turbine engine similar to the gas turbine engine 100 of FIG. 1, etc.). In the illustrated example of FIG. 7, the second active mount system 700 constrains three degrees of freedom of the coupled gas turbine engine by reacting vertical loads, lateral loads, and moments about the roll axis. In some such examples, imbalances in vertical and/or lateral loads between the second active mount system 700 and the other engine mounts can be used to react pitch and/or yaw moments applied to the gas turbine engine. These other mounts can include thrust links, front mounts and/or any other suitable connections between the gas turbine engine and the pylon 702. The example second active mount system 700 of FIG. 7 may be implemented to couple the engine casing 706 to the pylon 702 in a first direction or a second direction to react the loads and moments experienced in three degrees of freedom. In some examples, multiple second active mount systems 700 may be used in both a first direction and a second direction to react the loads and moments in six degrees of freedom.

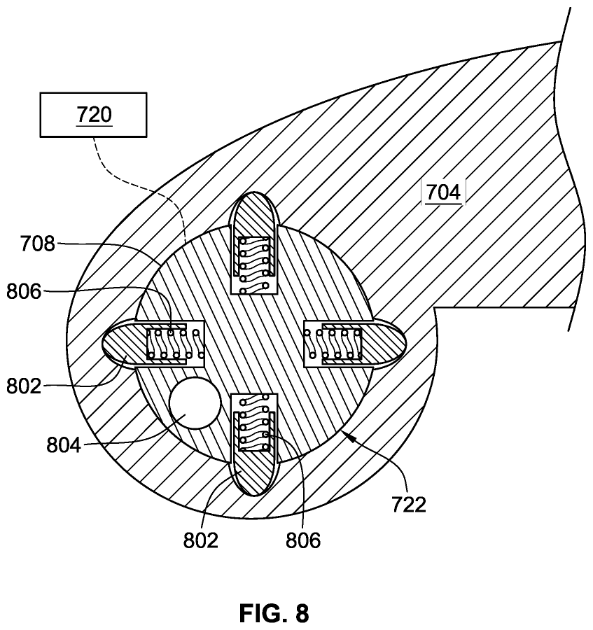

FIG. 8 shows an actuator 722 of the second active mount system 700 of FIG. 7. The actuator 722 is bored into the mount 704. The actuator 722 includes a first rotating lug 708, locking pins 802, a secondary lug bore 804, and springs 806. While FIG. 7 illustrates the actuator 722 coupled to the linkage 712 by the pin 724 at the secondary lug bore 804, FIG. 8 does not show the linkage 712 or the pin 724. FIG. 8 provides further detail regarding the actuator 722, and it is assumed that the movement of the secondary lug bore 804 drives the positioning of the linkage 712 because the pin 724 couples the secondary lug bore 804 to the linkage 712, which changes the angle of the linkage 712.

In operation, the locking pins 802 lock the first rotating lug 708 in place. The locking pins are extended and retracted by springs 806. If the FADEC 720 decides to tune the stiffness of the second active mount system 700 of FIG. 7, the FADEC 720 in FIG. 8 signals the actuator 722 to retract the springs 806 and subsequently retract the locking pins 802. The retraction of the springs 806 and locking pins 802 enable the first rotating lug 708 to rotate. The first rotating lug 708 rotates in the mount 704 to position the secondary lug bore 804 so that the angle associated with the coupled linkage 712 (FIG. 7) changes. Thus, changing the position of the secondary lug bore 804 tunes the stiffness associated with the second active mount system 700 of FIG. 7. Once the secondary lug bore 804 achieves the desired position associated with the desired stiffness of the second active mount system 700 of FIG. 7, the FADEC 720 of FIG. 8 signals the actuator 722 to extend the springs 806 to extend the locking pins 802 and lock the locking pins 802 in place, preventing further rotation of the actuator 722.

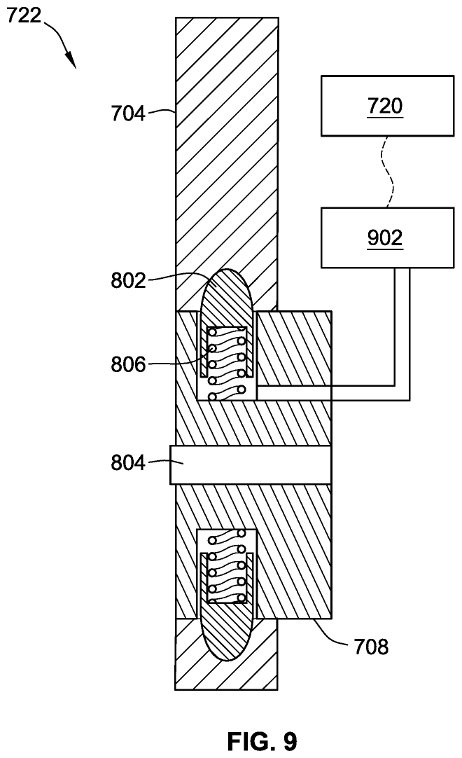

FIG. 9 depicts an example side sectional view of the actuator 722 of FIGS. 7 and 8. As shown, the actuator 722 is bored into the mount 704, with the secondary lug bore 804 extending through the actuator 722 to enable pinning of a linkage (e.g., the linkage 712 of FIG. 7) to the actuator 722. The locking pins 802 are held in place by springs 806 and are connected to an actuator gear mechanism 902. The actuator gear mechanism 902 receives signaling from the FADEC 720 to retract (e.g., by pulling in, etc.) the locking pins 802 and to rotate the first rotating lug 708. Once the first rotating lug 708 is rotated into its desired position to react the loads in the pitch and yaw directions, the FADEC 720 stops signaling the actuator gear mechanism 902 to release the springs 806 and subsequently pushes the springs 806 into a locking position to lock the angle of the linkage (e.g., the linkage 712 of FIG. 7) pinned to the secondary lug bore 804. By actively changing a linkage angle, the pitch and yaw stiffness of the second active mount system 700 is changed to help stabilize an engine (e.g., the gas turbine engine 100 of FIG. 1) during periods of propeller whirl.

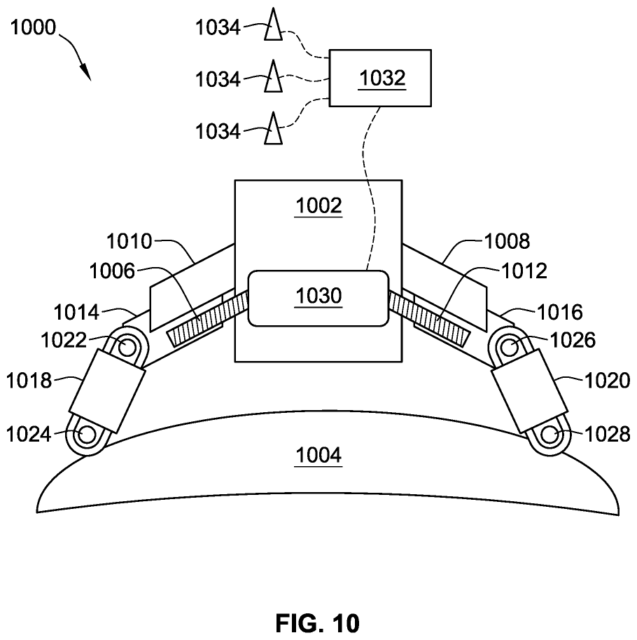

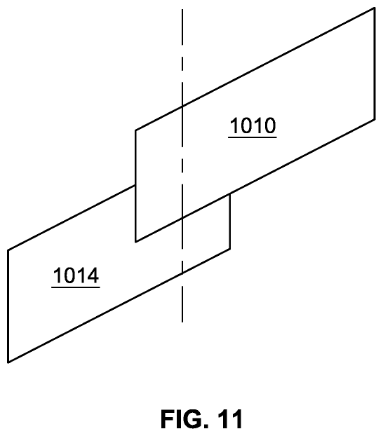

FIG. 10 demonstrates a third active mount system 1000. The third active mount system 1000 mounts a pylon 1002 to an engine casing 1004. The third active mount system 1000 includes: a first power screw 1006; an interface such as a first dovetail-type receiving interface 1010 and a first dovetail-type sliding interface 1014; a second interface such as a second dovetail-type receiving interface 1008 and a second dovetail-type sliding interface 1016; a first linkage 1018; a first pin 1022; a second pin 1024; a second power screw 1012; a second linkage 1020; a third pin 1026; a fourth pin 1028; an actuator 1030; and a FADEC 1032. The first pin 1022 couples a first end of the first linkage 1018 to the first dovetail-type sliding interface 1014. The second pin 1024 couples a second end of the first linkage 1018 to the engine casing 1004. The first power screw 1006 is coupled to the first dovetail-type sliding interface 1014 and to the actuator 1030. Similarly, the third pin 1026 couples a first end of the second linkage 1020 to the second dovetail-type sliding interface 1016. The fourth pin 1028 couples a second end of the second linkage 1020 to the engine casing 1004. The second power screw 1012 is coupled to the second dovetail-type sliding interface 1016 and to the actuator 1030. The actuator 1030 is electrically coupled to the FADEC 1032.

In operation, the FADEC 1032 uses a plurality of sensors 1034 to detect propeller whirl through a whirl detection function of the mounting vibration, angle of attack, torque, thrust, flow, conditional monitoring vibration, non-synchronous vibration, and other parameters. When propeller whirl is detected, the FADEC 1032 electrically signals the actuator 1030 to adjust the first and second power screws 1006, 1012. The power screws 1006, 1012 adjust the position of the first and second dovetail-type sliding interfaces 1014, 1016 inside the first and second dovetail-type receiving interfaces 1010, 1008. By adjusting the position of the first and second dovetail-type sliding interfaces 1014, 1016 inside the first and second dovetail-type receiving interfaces 1010, 1008, the actuator 1030 effectively changes the angles of the first and second linkages 1018, 1020. By changing the angles of the linkages 1018, 1020, the stiffness of the third active mount system 1000 is changed in the pitch and yaw directions. By achieving stiffness asymmetry, the third active mount system 1000 reduces propeller whirl.

The forces and moments generated by the weight and operation of the gas turbine engine associated with the engine casing 1004 are reacted between and/or by the third active mount system 1000 and/or the other mounts of a gas turbine engine (e.g., a gas turbine engine similar to the gas turbine engine 100 of FIG. 1, etc.). In the illustrated example of FIG. 10, the third active mount system 1000 constrains three degrees of freedom of the coupled gas turbine engine by reacting vertical loads, lateral loads, and moments about the roll axis. In some such examples, imbalances in vertical and/or lateral loads between the third active mount system 1000 and the other engine mounts can be used to react pitch and/or yaw moments applied to the gas turbine engine. These other mounts can include thrust links, front mounts and/or any other suitable connections between the gas turbine engine and the pylon 1002. The example third active mount system 1000 of FIG. 10 may be implemented to couple the engine casing 1004 to the pylon 1002 in a first direction or a second direction to react the loads and moments experienced in three degrees of freedom. In some examples, multiple third active mount systems 1000 may be used in both a first direction and a second direction to react the loads and moments in six degrees of freedom.

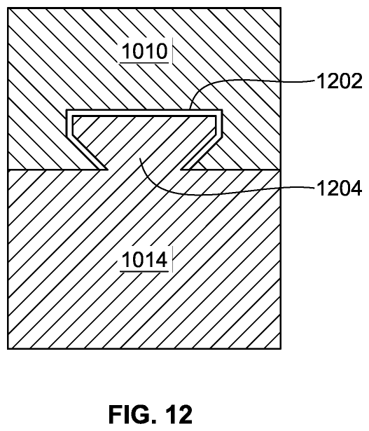

FIG. 11 illustrates the first dovetail-type receiving interface 1010, and first dovetail-type sliding interface 1014 of FIG. 10. In operation, the first dovetail-type receiving interface 1010 has a cavity to receive the first dovetail-type sliding interface 1014. A cross sectional view of the dovetail-type sliding and receiving interface is included in FIG. 12.

FIG. 12 illustrates a cross sectional view 1102 of the first dovetail-type receiving interface 1010 and first dovetail-type sliding interface 1014 of FIGS. 10 and 11. As shown in FIG. 12, the first dovetail-type sliding interface 1014 has a dovetail-type sliding protrusion 1204 that interfaces with a dovetail-type cavity 1202 of the first dovetail-type receiving interface 1010. The interface of the dovetail-type sliding protrusion 1204 with the dovetail-type cavity 1202 enables motion of the first dovetail-type receiving interface 1010 and first dovetail-type sliding interface 1014 over one another to effectively change the position of the first pin 1022 in FIG. 10 and subsequently change the angle of the first linkage 1018 of FIG. 10. The dovetail-type shape prevents decoupling of the first dovetail-type receiving interface 1010 from the first dovetail-type sliding interface 1014.

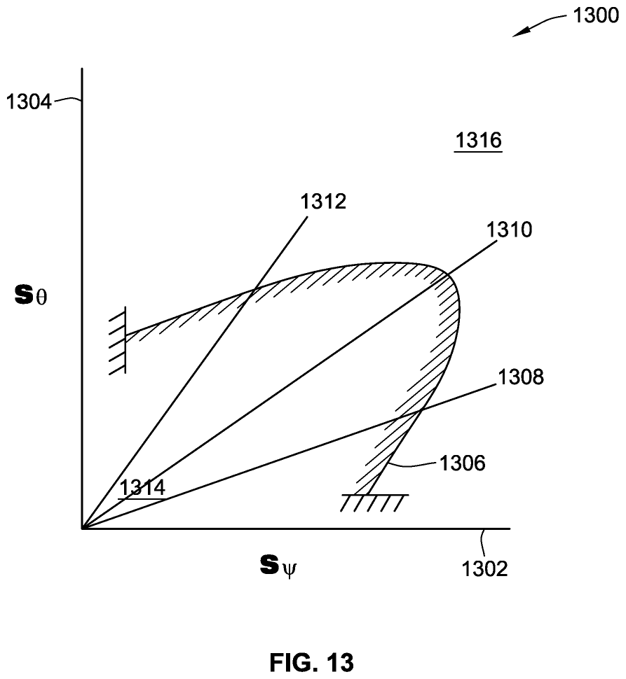

FIG. 13 illustrates a stiffness ratio graph 1300. The stiffness ratio graph 1300 graphs pitch stiffness, S_{θ} 1304 against yaw stiffness, S_{ψ} 1302. As shown on the stiffness ratio graph 1300, a stability curve 1306 illustrates an unstable region 1314 and a stable region 1316. The first, second, and third lines 1308, 1310, 1312 reflect stiffness ratios of pitch stiffness S_{θ} to yaw stiffness S_{ψ} of 1:2, 1:1, and 2:1, respectively. As shown by the second lines 1310, the stiffness ratio of 1:1 has the largest unstable area under the stability curve 1306.

In operation, the stiffness ratio graph 1300 is used by a FADEC, such as the FADEC 410 of FIGS. 4A, 4B, and 6, the FADEC 720 of FIGS. 7, 8, and 9, or the FADEC 1032 of FIG. 10, to determine a ratio of pitch and yaw stiffnesses to stabilize an aircraft close to the stability curve 1306. In a prior art mount system, such as the mount systems 200, 250 shown in FIGS. 2A and 2B, the linkages (e.g., linkages 220, 254, 256) are designed to have a maximum stiffness to help ensure operability in the stable region 1316 of the stiffness ratio graph 1300. The maximum stiffness design has disadvantages, such as louder cabin noise or an increased weight associated with manufacturing a thicker or larger linkage. In the examples disclosed herein, a controller or FADEC determines an improved ratio so that the stiffness associated with the linkages is on the stable side (e.g., within the stable region 1316) of the stability curve 1306 without requiring that the linkage be excessively thick or large to cover all potential conditions to which the aircraft may be subjected. In other examples herein, the stiffness and/or damping are adjustable to modulate a stiffness profile on the first, second, third, or other potential lines 1308, 1310, 1312. The examples disclosed herein enable usage of smaller (and thereby lighter) linkages that have a lesser stiffness associated than before which is also associated with decreased cabin noise.

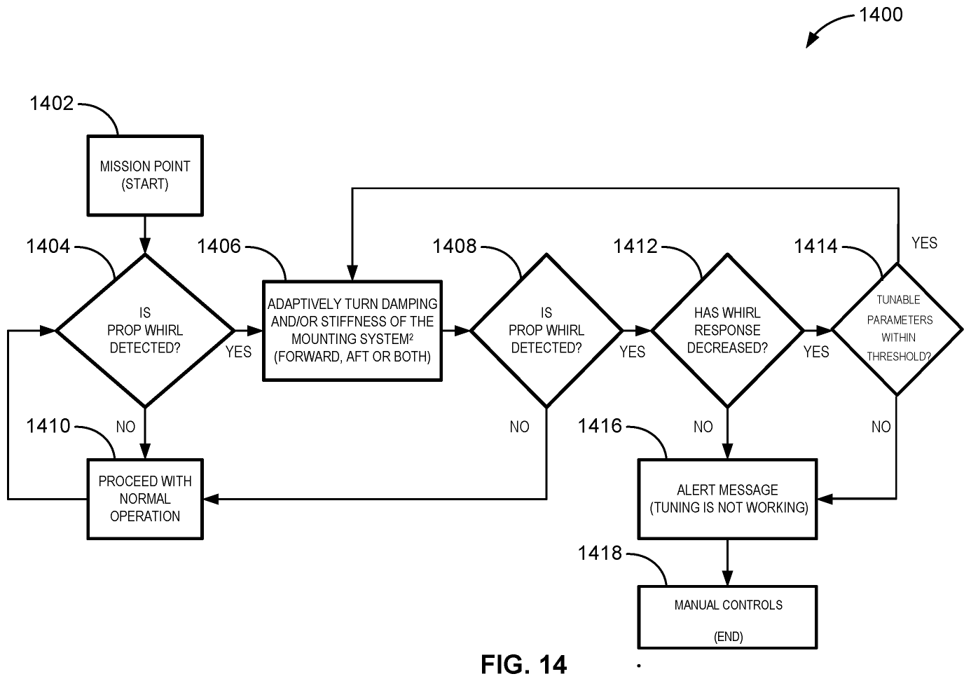

FIG. 14 shows a flowchart of the decisions and actions performed by a controller or FADEC (e.g., the FADEC 410 of FIGS. 4A, 4B, and 6, the FADEC 720 of FIGS. 7, 8, and 9, or the FADEC of FIG. 10) in examples disclosed herein. The example process 1400 starts with a mission point (block 1402). A mission point is a phase or objective within an aircraft's flight mission. Mission point encompasses various aspects, such as objectives or tasks an aircraft needs to accomplish during its flight. Mission points are used in planning and navigation to ensure that the aircraft follows a predefined path.

Once a mission point is established and flight parameters are determined to accomplish the associated objectives, the controller or FADEC uses a plurality of sensors to monitor parameters and determine if propeller whirl is detected (block 1404). Parameters that may be monitored are mount vibrations, conditional monitoring vibrations, flow parameters, thrust, torque, angle of attack, etc. In some examples, a function of the parameters may be calculated to determine a whirl detection threshold.

If no propeller whirl is detected, the controller or FADEC proceeds with normal operation and continued monitoring (block 1410). Similarly, if propeller whirl is detected but not enough to surpass the whirl detection threshold, the controller or FADEC proceeds with normal operation and continued monitoring. For example, the FADEC 1032 (FIG. 10) uses multiple sensors 1034 (FIG. 10) to measure a variety of parameters. The measured parameter data is used in a function to calculate whether the whirl detection threshold is surpassed. In this example, the function calculation does not exceed the whirl detection threshold.

When propeller whirl is detected, the controller or FADEC adaptively tunes the damping or stiffness of an active mount system associated with the aircraft (block 1406). The active mount system may be a forward mount system, an aft mount system, or both forward and aft, for example. For example, the FADEC 1032 uses multiple sensors 1034 to measure a variety of parameters. The measured parameter data is used in a function to calculate if the whirl detection threshold is surpassed. In this example, the function calculation exceeds the whirl detection threshold, so the FADEC 1032 sends a signal to the actuator 1030 (FIG. 10). The actuator 1030 actuates the power screws 1006, 1012 (FIG. 10) to adjust the angles of the linkages 1018, 1020 (FIG. 10) and thereby adjusting the stiffness associated with the third active mount system 1000 (FIG. 10).

Once the controller or FADEC adaptively tunes the damping or stiffness of the active mount system(s), the FADEC or controller continues to monitor a plurality of sensors for at least one parameter indicative of the propeller whirl response (block 1408). For example, the FADEC monitors parameters such as thrust and angle of attack. The monitored parameters are used in a function to determine whether a pre-defined propeller whirl response threshold has been exceeded. If there is no propeller whirl response detected, the aircraft and the controller or FADEC continue with normal operation and monitoring of the propeller whirl (block 1410). For example, if thrust increases and all other monitored parameters remain the same, the function calculates a new value indicative of propellor whirl. The new value of propeller whirl is compared to the pre-defined threshold indicating that propeller whirl response is present. In this example, the increase in thrust is insufficient to indicate the presence of propeller whirl.

If propeller whirl is still detected after the controller or FADEC adaptively tunes the damping or stiffness of the active mount system, the FADEC or controller compares the instantaneous whirl response to the previous whirl response (block 1412). In some examples, a trend analysis is performed to determine if the whirl response has decreased. For example, the FADEC 720 (FIG. 7) performs ongoing measurement of flight parameters by collecting data from the sensors 728 (FIG. 7). The FADEC 720 calculates a value indicative of propeller whirl. In this example, the value indicative of propeller whirl is greater than the propeller whirl detection threshold and is stored as the most recent propeller whirl indicator. Subsequently, the next collection of data related to flight parameters is fed into the FADEC 720 and used to calculate a new value indicative of propeller whirl. The FADEC 720 compares the new value indicative of propeller whirl to the stored most recent propeller whirl indicator. If the propeller whirl response has not decreased, the FADEC 720 may further tune the stiffness and/or damping of the second active mount system 700 (FIG. 7). If the propeller whirl response has decreased, the FADEC 720 may not take any action. In some examples, more than two data points are used to perform a more general trend analysis over time.

In the instance where the FADEC or controller has adaptively tuned the damping and/or stiffness of the associated active mount system(s) and the whirl response has not decreased, an alert is presented to an operator of the aircraft (block 1416). For example, the FADEC 410 (FIGS. 4A and 4B) performs ongoing measuring of flight parameters by collecting data from the sensors 412 (FIGS. 4A and 4B). The FADEC 410 calculates a value indicative of propeller whirl. In this example, the value indicative of propeller whirl is greater than the propeller whirl detection threshold, so the FADEC 410 stores the value indicative of propeller whirl and engages the actuators 406, 408 (FIGS. 4A and 4B) to activate the first active mount 330 (FIGS. 4A and 4B). The FADEC 410 continues to monitor flight parameter data as collected by the sensors 412. If the value indicative of propellor whirl response has not decreased as compared to the previous stored propeller whirl value, an alert is presented to the operator of the aircraft. The operator then has the option to use manual controls to stabilize the aircraft (block 1418).

If the FADEC or controller has adaptively tuned the damping and/or stiffness of the associated active mount system(s) and the whirl response has decreased, the controller or FADEC determines whether the tunable parameters are within a threshold or range (e.g., have more tuning that can be performed) (block 1414). For example, the FADEC 410 performs ongoing measuring of flight parameters by collecting data from the sensors 412. The FADEC 410 calculates a value indicative of propeller whirl. In this example, the value indicative of propeller whirl is greater than the propeller whirl detection threshold, so the FADEC 410 continues to hold the damping or stiffness of the first active mount 330 until the value indicative of propeller whirl is below the propeller whirl detection threshold.

If the tunable parameters can be adjusted further, the controller or FADEC returns to the tuning step to tune the damping or stiffness of the mount system (block 1406). For example, the FADEC 720 (FIG. 7) performs ongoing measuring of flight parameters by collecting data from the sensors 728 (FIG. 7). The FADEC 720 calculates a value indicative of propeller whirl. In this example, the value indicative of propeller whirl is greater than the propeller whirl detection threshold, so the FADEC 720 continues to tune the damping or stiffness of the second active mount system 700 (FIG. 7).

If the tunable parameters cannot be adjusted further, the controller or FADEC alerts the operator of the aircraft (block 1416). The operator then has the option to take over manual controls to stabilize the aircraft (block 1418).

The process terminates when an operator takes over manual controls to stabilize the aircraft or the process restarts when mission point is re-established.

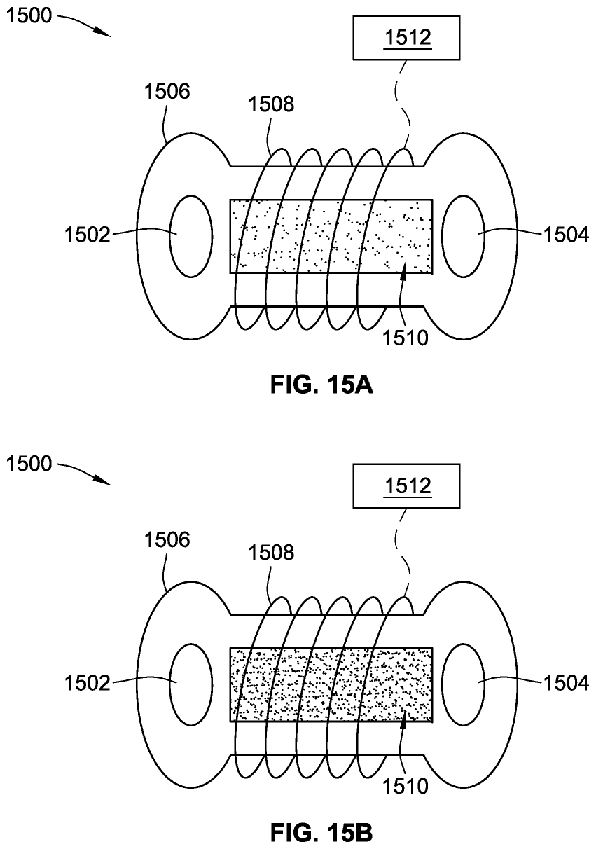

FIG. 15A shows an example linkage 1500 with tunable stiffness and damping. The linkage 1500 includes a linkage body 1506 with holes 1502, 1504, and magnetorheological fluid 1510. The magnetorheological fluid (MR fluid) is controllable by a magnetic field generated by a controller or FADEC 1512 applying low voltage levels to a coil 1508.

Magnetorheological fluids are non-Newtonian fluids. An MR fluid can reversibly change from a free-flowing, linear, viscous liquid to a semi-solid with a controllable yield strength in milliseconds when exposed to a magnetic field. FIG. 15A shows the MR fluid in a free-flowing, linear, viscous liquid state. This state is also referred to as the nominal or inactive state. In this state, the controller or FADEC 1512 is not applying any power to the coil 1508 to enable the fluid to remain in the inactive state.

FIG. 15B shows the active state of linkage 1500. In the active state, the controller or FADEC 1512 applies low voltage levels to the coil 1508. By applying low voltage levels, the free-flowing, linear, viscous liquid that is the MR fluid 1510 of FIG. 15A reversibly changes to a semi-solid MR fluid 1510 with a controllable yield strength in FIG. 15B. With voltage applied across the fluid, the fluid becomes activated with an apparent increase in area, causing an increase in stiffness. By using MR fluid in conjunction with linkages, the mount stiffness and damping are controlled as per the stability curve 1306 in FIG. 13 for the specific engine systems.

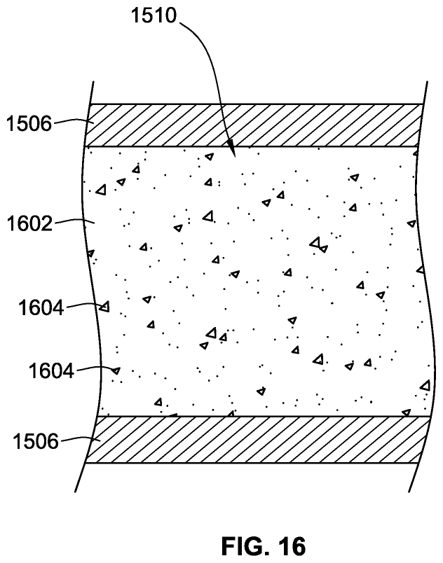

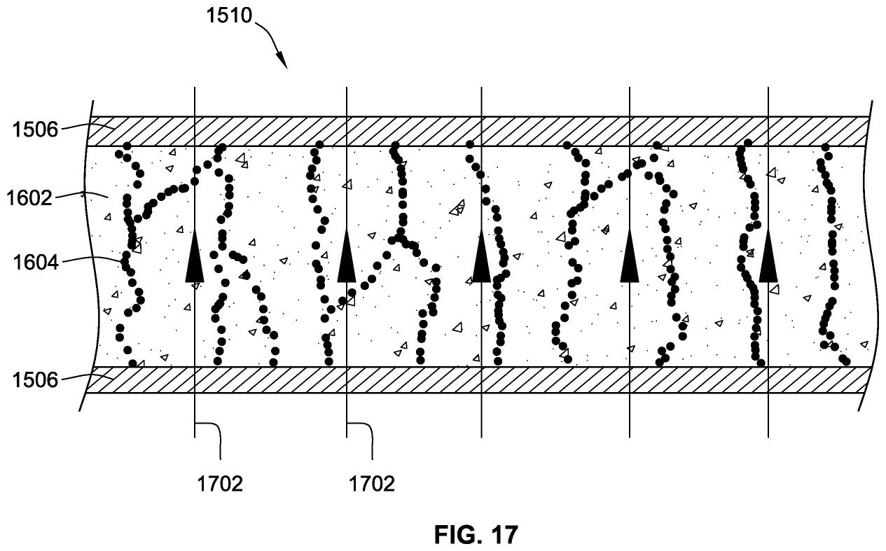

FIGS. 16 and 17 illustrate the usage of MR fluid further. FIG. 16 shows the MR fluid 1510 of FIG. 15A surrounded by linkage body 1506. The MR fluid 1510 includes carrier oil 1602 and magnetic particles 1604. In an inactive state, the magnetic particles 1604 are free-flowing in the carrier oil 1602. Without any engagement, the magnetic particles 1604 and carrier oil 1602 are free-flowing, linear, and viscous. In contrast with FIG. 16, FIG. 17 shows the active state of MR fluid 1510 surrounded by linkage body 1506. When low voltage levels are applied to the coils 1508 in FIG. 15A, magnetic flux 1702 is created. The magnetic flux 1702 cause the magnetic particles 1604 to form chains in the carrier oil 1602 in the direction of the magnetic flux 1702. The chains create a semi-solid state and depending on the strength of the magnetic field, create a controllable yield strength. Therefore, by a controller or FADEC (e.g., the controller or FADEC 1512 in FIGS. 15A and 15B), the stiffness and damping of a linkage can be tuned.

The linkage 1500 of FIGS. 15A and 15B can be used in conjunction with the mount systems disclosed herein or with the mount systems. For example, the first active mount system 330 of FIGS. 4A and 4B or the second active mount system 700 of FIG. 7 may replace the associated linkages with linkages similar to the linkage of FIG. 15. Similarly, the third active mount system 1000 of FIG. 10 may replace the dovetail-type receiving interface 1010 (FIG. 10) or the dovetail-type sliding interface 1014 (FIG. 10) with an MR fluid interface. Additionally, the mount systems of FIGS. 2A and 2B may also replace the linkages with linkages similar to the linkage of FIG. 15.

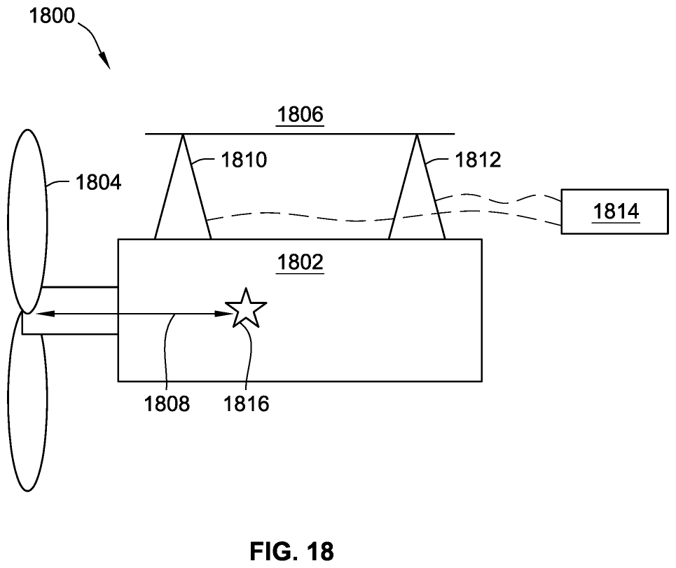

FIG. 18 shows a block diagram of a mount system 1800. The mount system 1800 includes an engine 1802, a propeller 1804, a forward mount 1810, an aft mount 1812, a pylon 1806, and a controller 1814. The forward mount 1810 and the aft mount 1812 have an associated stiffness and damping. The engine 1802 has a pivot length 1808 from the base of the propeller 1804 to a pivot point represented by a star 1816.

In operation, FIG. 18 represents an active mount system 1800 in which the controller or FADEC 1814 measures at least one parameter indicating propeller whirl stability, such as a high angle of attack, a high cross wind, or non-synchronous vibration at or beyond a threshold. By tuning the stiffness of the mount system 1800, the controller or FADEC 1814 can adjust the pivot length 1808 forward or aft (e.g., simultaneously making the forward mount softer and the aft mount stiffer to move the pivot point aft). Adjusting the pivot length 1808 produces a stabilizing effect. Additionally, increasing stator damping of the forward mount 1810 and aft mount 1812 produces a stabilizing effect on the propeller 1804.

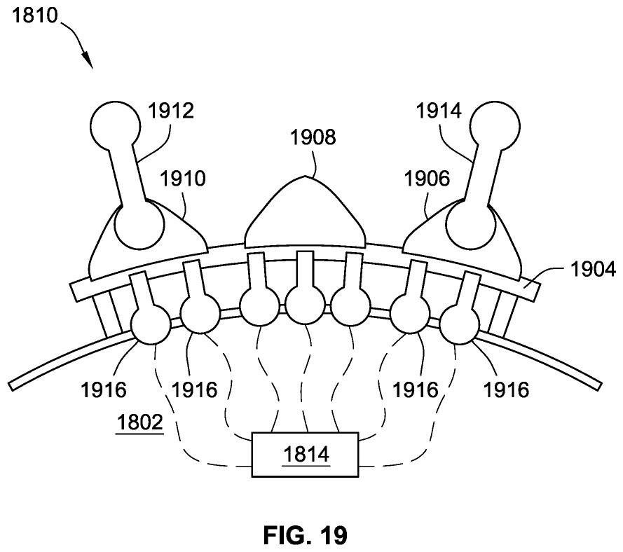

FIG. 19 shows a cross-sectional view of the forward mount 1810 of FIG. 18. The forward mount 1810 includes mount links 1912, 1914, clevises 1906, 1908, 1910, a mount platform 1904 standing on the frame of the engine 1802, and dampers 1916 connected to the controller or FADEC 1814.

The dampers 1916 of FIG. 19 are between the engine 1802 and the mount platform 1904. In an example, the dampers 1916 are frictional dampers that are designed for increasing stator damping in the mount loadpath. By increasing stator damping in the mount loadpath, the damping decreases the effect large deflections have during periods of propeller whirl. In effect, the improves the stability of the engine 1802.

In an alternate example, the dampers 1916 of FIG. 19 are replaced with shape memory alloy (SMA) wires (not shown) that are electro-thermally actuated. The SMA wires are used for modifying effective stiffness and damping in the mount loadpath by electrically controlling the temperature surrounding the wires. This is done by using resistive heating elements or electrical currents to heat an SMA wire above its transition temperature. In this example, the controller or FADEC 1814 supplies electrical current to the SMA wires to control the SMA wire temperature.

SMA wires have two phases: the high-temperature phase (austenite) and the low temperature phase (martensite). By heating the SMA wire above its transition temperature, the wire transitions into its austenite phase and changes shape from an original shape into a target shape. When the SMA wire temperature is cooled or falls below the transition temperature, the wire reverts to the martensite phase and returns to its original shape.

In operation, using SMA wires changing between different shapes (different lengths and width), the effective stiffness and damping in the mount loadpath can be effectively controlled.

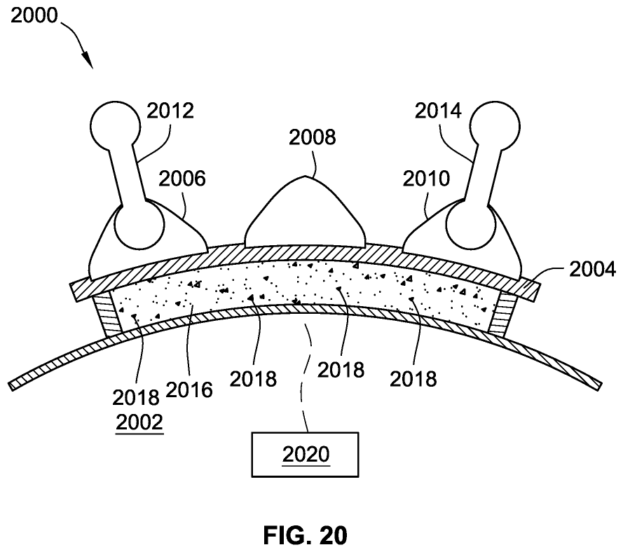

FIG. 20 illustrates a cross section of a fourth active mount system 2000. The fourth active mount system includes a mount platform 2004 extending from a frame of an engine 2002. Mount clevises 2006, 2008, 2010 extend from the mount platform 2004 and enable linkages 2012, 2014 to couple to the mount clevises 2006, 2010. A carrier oil 2016 with magnetic particles 2018 under the mount platform 2004 create a magnetorheological fluid encapsulated by the mount platform 2004 and the engine casing 2002. A FADEC 2020 is shown as connected to a wire coil (not shown) around the MR fluid.

In operation, the fourth active mount system 2000 uses the principles discussed in the examples of FIGS. 16 and 17. The carrier oil 2016 and magnetic particles 2018 remain in a nominal (inactive) state until a low voltage is applied by the FADEC 2020. The low voltage around coils produces magnetic flux. The magnetic flux vectors cause the magnetic particles to align in chains. The chains produce a semi-solid state which has a controllable stiffness and damping. The FADEC 2020 then adjusts the low voltage supplied to the MR fluid to tune the system to achieve the damping and stiffness for propeller whirl stability.

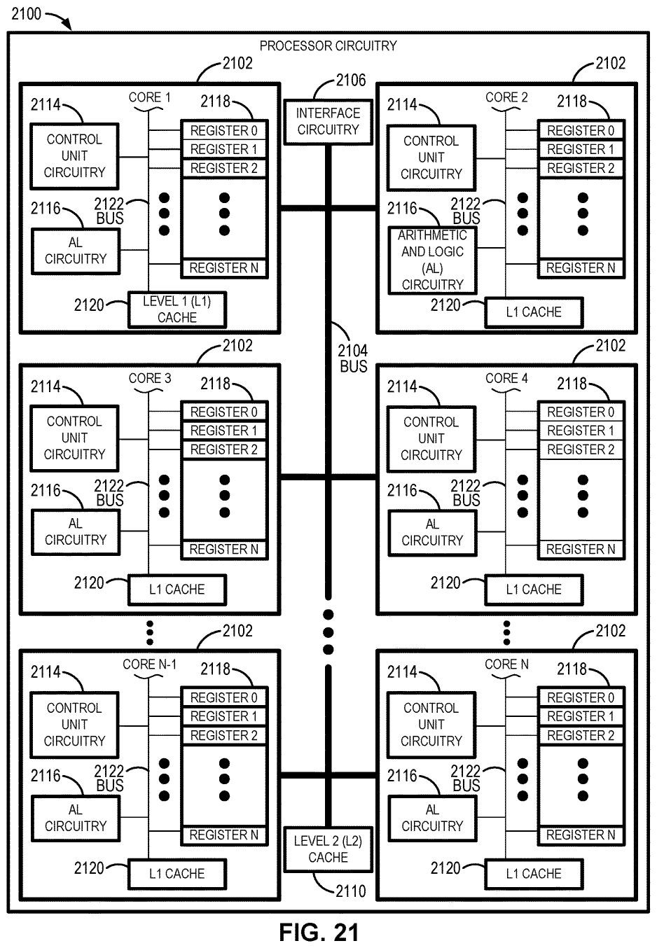

FIG. 21 is a block diagram of an example implementation of the FADEC 410 of FIGS. 4A, 4B, and 6, the FADEC 720 of FIGS. 7, 8, and 9, the FADEC 1032 of FIG. 10, the FADEC 1512 of FIGS. 15A and 15B, the controller or FADEC 1814 of FIGS. 18 and 19, and the FADEC 2020 of FIG. 20. In this example, the FADEC 410 of FIGS. 4A, 4B, and 6, the FADEC 720 of FIGS. 7, 8, and 9, the FADEC 1032 of FIG. 10, the FADEC 1512 of FIGS. 15A and 15B, the controller or FADEC 1814 of FIGS. 18 and 19, and the FADEC 2020 of FIG. 20 is implemented by a microprocessor 2100. For example, the microprocessor 2100 may be a general-purpose microprocessor (e.g., general-purpose microprocessor circuitry). The microprocessor 2100 executes some or all of the machine-readable instructions of the flowcharts of FIG. 14 to effectively instantiate the circuitry of FIG. 2 as logic circuits to perform operations corresponding to those machine readable instructions. In some such examples, the FADEC 410 of FIGS. 4A, 4B, and 6, the FADEC 720 of FIGS. 7, 8, and 9, the FADEC 1032 of FIG. 10, the FADEC 1512 of FIGS. 15A and 15B, the controller or FADEC 1814 of FIGS. 18 and 19, and the FADEC 2020 of FIG. 20 is instantiated by the hardware circuits of the microprocessor 2100 in combination with the machine-readable instructions. For example, the microprocessor 2100 may be implemented by multi-core hardware circuitry such as a CPU, a DSP, a GPU, an XPU, etc. Although it may include any number of example cores 2102 (e.g., 1 core), the microprocessor 2100 of this example is a multi-core semiconductor device including N cores. The cores 2102 of the microprocessor 2100 may operate independently or may cooperate to execute machine readable instructions. For example, machine code corresponding to a firmware program, an embedded software program, or a software program may be executed by one of the cores 2102 or may be executed by multiple ones of the cores 2102 at the same or different times. In some examples, the machine code corresponding to the firmware program, the embedded software program, or the software program is split into threads and executed in parallel by two or more of the cores 2102. The software program may correspond to a portion or all of the machine readable instructions and/or operations represented by the flowcharts of FIG. 14.

The cores 2102 may communicate by a first example bus 2104. In some examples, the first bus 2104 may be implemented by a communication bus to effectuate communication associated with one(s) of the cores 2102. For example, the first bus 2104 may be implemented by at least one of an Inter-Integrated Circuit (I2C) bus, a Serial Peripheral Interface (SPI) bus, a PCI bus, or a PCIe bus. Additionally or alternatively, the first bus 2104 may be implemented by any other type of computing or electrical bus. The cores 2102 may obtain data, instructions, and/or signals from one or more external devices by example interface circuitry 2106. The cores 2102 may output data, instructions, and/or signals to the one or more external devices by the interface circuitry 2106. Although the cores 2102 of this example include example local memory 2120 (e.g., Level 1 (L1) cache that may be split into an L1 data cache and an L1 instruction cache), the microprocessor 2100 also includes example shared memory 2110 that may be shared by the cores (e.g., Level 2 (L2 cache)) for high-speed access to data and/or instructions. Data and/or instructions may be transferred (e.g., shared) by writing to and/or reading from the shared memory 2110. The local memory 2120 of each of the cores 2102 and the shared memory 2110 may be part of a hierarchy of storage devices including multiple levels of cache memory and the main memory. Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 2102 may be referred to as a CPU, DSP, GPU, etc., or any other type of hardware circuitry. Each core 2102 includes control unit circuitry 2114, arithmetic and logic (AL) circuitry (sometimes referred to as an ALU) 2116, a plurality of registers 2118, the local memory 2120, and a second example bus 2122. Other structures may be present. For example, each core 2102 may include vector unit circuitry, single instruction multiple data (SIMD) unit circuitry, load/store unit (LSU) circuitry, branch/jump unit circuitry, floating-point unit (FPU) circuitry, etc. The control unit circuitry 2114 includes semiconductor-based circuits structured to control (e.g., coordinate) data movement within the corresponding core 2102. The AL circuitry 2116 includes semiconductor-based circuits structured to perform one or more mathematic and/or logic operations on the data within the corresponding core 2102. The AL circuitry 2116 of some examples performs integer based operations. In other examples, the AL circuitry 2116 also performs floating-point operations. In yet other examples, the AL circuitry 2116 may include first AL circuitry that performs integer-based operations and second AL circuitry that performs floating-point operations. In some examples, the AL circuitry 2116 may be referred to as an Arithmetic Logic Unit (ALU).

The registers 2118 are semiconductor-based structures to store data and/or instructions such as results of one or more of the operations performed by the AL circuitry 2116 of the corresponding core 2102. For example, the registers 2118 may include vector register(s), SIMD register(s), general-purpose register(s), flag register(s), segment register(s), machine-specific register(s), instruction pointer register(s), control register(s), debug register(s), memory management register(s), machine check register(s), etc. The registers 2118 may be arranged in a bank as shown in FIG. 21. Alternatively, the registers 2118 may be organized in any other arrangement, format, or structure, such as by being distributed throughout the core 2102 to shorten access time. The second bus 2122 may be implemented by at least one of an I2C bus, a SPI bus, a PCI bus, or a PCIe bus.

Each core 2102 and/or, more generally, the microprocessor 2100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 2100 is a semiconductor device fabricated to include many transistors interconnected to implement the structures described above in one or more integrated circuits (ICs) contained in one or more packages.

The microprocessor 2100 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 2100, in the same chip package as the microprocessor 2100 and/or in one or more separate packages from the microprocessor 2100.

Examples disclosed herein include engine mount systems with active control for adaptive stiffness and damping for improved propeller whirl stability. The examples disclosed herein can decrease the weight of the mount system or can improve engine dynamics such as vibrations and cabin noise. Examples disclosed can stabilize the propeller whirl response despite perturbations in flight conditions, such as the angle of attack. Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

Further aspects of the invention are provided by the subject matter of the following clauses:

An apparatus for an unducted engine, the apparatus comprising a mount system to connect an engine casing of an aircraft to a pylon, a plurality of sensors to measure at least one parameter indicating propeller whirl stability, and a controller to tune a stiffness of the mount system depending on a function of the at least one parameter measured by the plurality of sensors, the controller to tune the stiffness of the mount system by signaling an actuator, the mount system including a first linkage coupling the engine casing to the pylon in a first direction, a second linkage coupling the engine casing to the pylon in the first direction, a first pin coupling the first and second linkages to the engine casing, a second pin coupling the first and second linkages to the pylon, an interface to engage with the first and second linkages, the interface to at least one of rotate or slide, and the actuator to cause the interface to engage with the first and second linkages based on the signaling from the controller.

The apparatus of any preceding clause, wherein the mount system further includes a third linkage coupling the engine casing to the pylon in a second direction, a fourth linkage coupling the engine casing to the pylon in the second direction, a third pin coupling the first and second linkages to the engine casing of the aircraft, a fourth pin coupling the first and second linkages to the pylon, a second interface to engage with the third and fourth linkages, the second interface to at least one of rotate or slide, and a second actuator to cause the interface to engage with the third and fourth linkages based on the signaling from the controller.

The apparatus of any preceding clause, wherein the first and second linkages form a failsafe load path to a primary load path, the primary load path including at least a third linkage.

The apparatus of any preceding clause, wherein the interface is tapered to fit into a slot in the first linkage.

The apparatus of any preceding clause, wherein the at least one parameter is one of an angle of attack, a thrust, a torque, a vibration, or a flow.

The apparatus of any preceding clause, wherein the actuator is at least one of a hydraulic actuator, a rack and pinion actuator, a piezoelectric actuator, or a shape memory alloy actuator.

The apparatus of any preceding clause, wherein the interface is a dovetail-type sliding interface.

The apparatus of any preceding clause, wherein the mount system further includes a dovetail-type receiving interface to complement the dovetail-type sliding interface.

The apparatus of any preceding clause, wherein the mount system further includes a locking pin, the locking pin positioned to reinforce the connection between the actuator and the interface.

The apparatus of any preceding clause, wherein, when tuning the stiffness of the mount system does not cause a change in a parameter measured by the plurality of sensors, the controller sends an alert message.

A mount system including a first linkage coupling an engine casing to a pylon in a first direction, a second linkage coupling the engine casing to the pylon in a first direction, a first pin coupling the first and second linkages to the engine casing, a second pin coupling the first and second linkages to the pylon, an interface to engage with the first and second linkages, the interface to at least one of rotate or slide, and an actuator to cause the interface to engage with the first and second linkages based on signaling from a controller.

The mount system of any preceding clause, wherein the mount system further includes a third linkage coupling the engine casing to the pylon in a second direction, a fourth linkage coupling the engine casing to the pylon in a second direction, a third pin coupling the first and second linkages to the engine casing, a fourth pin coupling the first and second linkages to the pylon, a second interface to engage with the third and fourth linkages, the second interface to at least one of rotate or slide, and a second actuator to cause the interface to engage with the third and fourth linkages based on the signaling from the controller.

The mount system of any preceding clause, wherein the first and second linkages are a failsafe load path to a primary load path, the primary load path including at least a third linkage.

The mount system of any preceding clause, wherein the interface is tapered to fit into a slot in the first linkage.

The mount system of any preceding clause, wherein the first linkage is filled with a magnetorheological fluid.

The mount system of any preceding clause, further comprising a wire coil around the magnetorheological fluid.

The mount system of any preceding clause, wherein the actuator is at least one of a hydraulic actuator, a rack and pinion actuator, a piezoelectric actuator, or a shape memory alloy actuator.

The mount system of any preceding clause, wherein the interface is a dovetail-type sliding interface.

The mount system of any preceding clause, wherein the mount system further includes a dovetail-type receiving interface to complement the dovetail-type sliding interface.

The mount system of any preceding clause, wherein the mount system further includes a locking pin, the locking pin positioned to reinforce the connection between the actuator and the interface.

A controller to adaptively tune the stiffness of a mounting system, the controller to perform the steps comprising measure a plurality of flight parameters indicative of propeller whirl, determine if a predetermined threshold of propeller whirl instability is exceeded, and tuning the stiffness of the mount system.

The controller of any preceding clause, wherein the controller is further to monitor, after tuning the stiffness, the propeller whirl instability to determine whether a measurement of propeller whirl instability has decreased.

The controller of any preceding clause, wherein the controller is further to analyze a trend of the propeller whirl instability.

The controller of any preceding clause, wherein the controller is further to send, after determining that the tuning the stiffness of the mount system does not decrease propeller whirl instability, an alert message.

The controller of any preceding clause, wherein the controller is further to continue to tune the stiffness of the mount system until propeller whirl is no longer detected.

A method of adaptively tuning a stiffness of a mount system, the method comprising measure a plurality of flight parameters indicative of propeller whirl, determine if a predetermined threshold of propeller whirl instability is exceeded, and tuning the stiffness of the mount system.

The method of any preceding clause further including monitoring, after tuning the stiffness, the propeller whirl instability to determine whether a measurement of propeller whirl instability has decreased.

The method of any preceding clause further including analyzing a trend of the propeller whirl instability.

The method of any preceding clause further including sending, after determining that the tuning the stiffness of the mount system does not decrease propeller whirl instability, an alert message.

The method of any preceding clause further including continuing to tune the stiffness of the mount system until propeller whirl is no longer detected.

A non-transitory computer readable medium comprising instructions to cause programmable circuitry to at least measure a plurality of flight parameters indicative of propeller whirl, determine if a predetermined threshold of propeller whirl instability is exceeded, and tuning the stiffness of the mount system.

The non-transitory computer readable medium of any preceding clause further including to monitor, after tuning the stiffness, the propeller whirl instability to determine whether a measurement of propeller whirl instability has decreased.

The non-transitory computer readable medium of any preceding clause further including to analyze a trend of the propeller whirl instability.

The non-transitory computer readable medium of any preceding clause further including to send, after determining that the tuning the stiffness of the mount system does not decrease propeller whirl instability, an alert message.

The non-transitory computer readable medium of any preceding clause further including to continue to tune the stiffness of the mount system until propeller whirl is no longer detected.

A machine readable storage medium comprising instructions to cause programmable circuitry to at least measure a plurality of flight parameters indicative of propeller whirl, determine if a predetermined threshold of propeller whirl instability is exceeded, and tuning the stiffness of the mount system.

The machine readable storage medium of any preceding clause further including to monitor, after tuning the stiffness, the propeller whirl instability to determine whether a measurement of propeller whirl instability has decreased.

The machine readable storage medium of any preceding clause further including to analyze a trend of the propeller whirl instability.

The machine readable storage medium of any preceding clause further including to send, after determining that the tuning the stiffness of the mount system does not decrease propeller whirl instability, an alert message.

The machine readable storage medium of any preceding clause further including to continue to tune the stiffness of the mount system until propeller whirl is no longer detected.

A means for adaptively tuning a stiffness of a mount system, the stiffness associated with a linkage of the mount system.

The means of any preceding clause, wherein the linkage contains magnetorheological fluid.

The means of any preceding clause, wherein the tuning of the mount system includes at least measuring a plurality of flight parameters, monitoring propeller whirl instability, and making an adjustment to a linkage of the mount system.

The means of any preceding clause, wherein the adjustment to a linkage of the mount system includes adjusting at least one of the angle of the linkage, the engagement of the linkage, of the damping factor of the linkage.

An apparatus for an unducted engine, the apparatus comprising a mount system to connect an engine casing of an aircraft to a pylon, a plurality of sensors to measure at least one parameter indicating propeller whirl stability, and a controller to tune a stiffness of the mount system depending on a function of the at least one parameter measured by the plurality of sensors, the controller to tune the stiffness of the mount system by signaling an actuator, the mount system including a first linkage coupling the engine casing to the pylon in a first direction, a second linkage coupling the engine casing to the pylon in the first direction, a first pin coupling the first and second linkages to the engine casing, a second pin coupling the first and second linkages to the pylon, a sliding sleeve to engage with the first and second linkages, the sliding sleeve to slide, and the actuator to cause the sliding sleeve to engage with the first linkage and a lug based on the signaling from the controller.

The apparatus of any preceding clause, wherein the mount system further includes a second sliding sleeve, the second sliding sleeve to engage with the second linkage and the lug based on signaling from the controller.

The apparatus of any preceding clause, wherein the mount system further includes a third linkage coupling the engine casing to the pylon in a second direction, a fourth linkage coupling the engine casing to the pylon in the second direction, a third pin coupling the third and fourth linkages to the engine casing of the aircraft, a fourth pin coupling the third and fourth linkages to the pylon, a third sliding sleeve to engage the third linkage with a second lug, and a second actuator to cause a fourth sliding sleeve to engage with the fourth linkage with the second lug based on the signaling from the controller.

The apparatus of any preceding clause, wherein the first and second linkages form a failsafe load path to a primary load path, the primary load path including at least a third linkage.

The apparatus of any preceding clause, wherein the interface is tapered to fit into a slot in the first linkage.

The apparatus of any preceding clause, wherein the at least one parameter is one of an angle of attack, a thrust, a torque, a vibration, or a flow.

The apparatus of any preceding clause, wherein, when tuning the stiffness of the mount system does not cause a change in a parameter measured by the plurality of sensors, the controller sends an alert message.

An apparatus for an unducted engine, the apparatus comprising a mount system to connect an engine casing of an aircraft to a pylon, a plurality of sensors to measure at least one parameter indicating propeller whirl stability, and a controller to tune a stiffness of the mount system depending on a function of the at least one parameter measured by the plurality of sensors, the controller to tune the stiffness of the mount system by signaling an actuator, the mount system including a first linkage coupling the engine casing to the pylon in a first direction, a second linkage coupling the engine casing to the pylon in the first direction, a first pin coupling the first linkage to the engine casing, a second pin coupling the first linkages to the pylon, a rotating lug to adjust an angle of the first linkage, and the actuator to cause the rotating lug to disengage with a spring and rotate based on the signaling from the controller.

The apparatus of any preceding clause, wherein the mount system further includes a second actuator and a second rotating lug, the second rotating lug to engage with the second linkage and a second spring based on signaling from the controller.

The apparatus of any preceding clause, wherein the mount system further includes a third linkage coupling the engine casing to the pylon in a second direction, a fourth linkage coupling the engine casing to the pylon in the second direction, a third pin coupling the third linkages to the engine casing of the aircraft, a fourth pin coupling the third linkages to the pylon, a third rotating lug to adjust an angle of the third linkage, and a second actuator to cause a fourth rotating lug to adjust an angle of the fourth linkage based on the signaling from the controller.

The apparatus of any preceding clause, wherein the at least one parameter is one of an angle of attack, a thrust, a torque, a vibration, or a flow.

The apparatus of any preceding clause, wherein, when tuning the stiffness of the mount system does not cause a change in a parameter measured by the plurality of sensors, the controller sends an alert message.

An apparatus for an unducted engine, the apparatus comprising a mount system to connect an engine casing of an aircraft to a pylon, a plurality of sensors to measure at least one parameter indicating propeller whirl stability, and a controller to tune a stiffness of the mount system depending on a function of the at least one parameter measured by the plurality of sensors, the controller to tune the stiffness of the mount system by signaling an actuator, the mount system including a first linkage coupling the engine casing to a dovetail-type sliding interface in a first direction, a second linkage coupling the engine casing to a second dovetail-type sliding interface in the first direction, a first pin coupling the first linkage to the engine casing, a second pin coupling the first linkage to the dovetail-type sliding interface, a third pin coupling the second linkage to the engine casing, a fourth pin coupling the second linkage to the second dovetail-type sliding interface, a first power screw to adjust an angle of the first linkage, a second power screw to adjust an angle of the second linkage and the actuator to cause the first power screw to rotate and to cause the second power screw to rotate based on the signaling from the controller.

The apparatus of any preceding clause, wherein the mount system further includes a third linkage, a fourth linkage, a third power screw, a fourth power screw, a third dovetail-type sliding interface, a fourth dovetail-type sliding interface, a fifth pin, a sixth pin, a seventh pin, and an eighth pin, the third linkage coupling the engine casing to the dovetail-type sliding interface in a second direction, a fourth linkage coupling the engine casing to the dovetail-type sliding interface in the second direction, the fifth pin coupling the third linkage to the engine casing of the aircraft, a sixth pin coupling the third linkage to the third dovetail-type sliding interface, the seventh pin coupling the fourth linkage to the engine casing of the aircraft, the eighth pin coupling the fourth linkage to the fourth dovetail-type sliding interface, and a second actuator to cause the third power screw to rotate and to cause the fourth power screw to rotate based on the signaling from the controller.

The apparatus of any preceding clause, wherein the at least one parameter is one of an angle of attack, a thrust, a torque, a vibration, or a flow.

The apparatus of any preceding clause, wherein, when tuning the stiffness of the mount system does not cause a change in a parameter measured by the plurality of sensors, the controller sends an alert message.

An apparatus for an unducted engine, the apparatus comprising a mount system to connect an engine casing of an aircraft to a pylon, a plurality of sensors to measure at least one parameter indicating propeller whirl stability, and a controller to tune a stiffness of the mount system depending on a function of the at least one parameter measured by the plurality of sensors, the controller to tune the stiffness of the mount system by signaling an coil, the mount system including a first linkage filled with magnetorheological fluid and a second linkage filled with magnetorheological fluid.

The apparatus of any preceding clause, wherein the magnetorheological fluid includes a carrier oil and a plurality of magnetic particles.

An apparatus for an unducted engine, the apparatus comprising a mount system to connect an engine casing of an aircraft to a pylon, the mount system including at least one of a frictional damper or a smart metal alloy wire, a plurality of sensors to measure at least one parameter indicating propeller whirl stability, and a controller to tune a stiffness of the mount system depending on a function of the at least one parameter measured by the plurality of sensors, the controller to tune the stiffness of the mount system by signaling the at least one of a frictional damper or a smart metal alloy wire.

The following claims are hereby incorporated into this Detailed Description by this reference, with each claim standing on its own as a separate embodiment of the present disclosure.

What is claimed is:

1. An apparatus for an unducted engine, the apparatus comprising:
a mount system to connect an engine casing of an aircraft to a pylon;
a plurality of sensors to measure at least one parameter indicating propeller whirl stability; and
a controller to tune a stiffness of the mount system depending on a function of the at least one parameter measured by the plurality of sensors, the controller to tune the stiffness of the mount system by signaling an actuator,
the mount system including:
a first linkage coupling the engine casing to the pylon in a first direction;
a second linkage coupling the engine casing to the pylon in the first direction;
a first pin coupling the first and second linkages to the engine casing;
a second pin coupling the first and second linkages to the pylon;
an interface to engage with the first and second linkages, the interface to at least one of rotate or slide; and
the actuator to cause the interface to engage with the first and second linkages based on the signaling from the controller.

2. The apparatus of claim 1, wherein the mount system further includes:
a third linkage coupling the engine casing to the pylon in a second direction;
a fourth linkage coupling the engine casing to the pylon in the second direction;
a third pin coupling the third and fourth linkages to the engine casing of the aircraft;
a fourth pin coupling the third and fourth linkages to the pylon;
a second interface to engage with the third and fourth linkages, the second interface to at least one of rotate or slide; and
a second actuator to cause the interface to engage with the third and fourth linkages based on the signaling from the controller.

3. The apparatus of claim 1, wherein the first and second linkages form a failsafe load path to a primary load path, the primary load path including at least a third linkage.

4. The apparatus of claim 1, wherein the interface is tapered to fit into a slot in the first linkage.

5. The apparatus of claim 1, wherein the at least one parameter is one of an angle of attack, a thrust, a torque, a vibration, or a flow.

6. The apparatus of claim 1, wherein the actuator is at least one of a hydraulic actuator, a rack and pinion actuator, a piezoelectric actuator, or a shape memory alloy actuator.

7. The apparatus of claim 1, wherein the interface is a dovetail-type sliding interface.

8. The apparatus of claim 7, wherein the mount system further includes a dovetail-type receiving interface movably retaining the dovetail-type sliding interface.

9. The apparatus of claim 1, wherein the mount system further includes a locking pin, the locking pin positioned to reinforce the connection between the actuator and the interface.

10. The apparatus of claim 1, wherein, when tuning the stiffness of the mount system does not cause a change in a parameter measured by the plurality of sensors, the controller generates an alert message.

11. A mount system including:
a first linkage coupling an engine casing to a pylon in a first direction;
a second linkage coupling the engine casing to the pylon in a first direction;
a first pin coupling the first and second linkages to the engine casing;
a second pin coupling the first and second linkages to the pylon;
an interface to engage with the first and second linkages, the interface to at least one of rotate or slide; and
an actuator to cause the interface to engage with the first and second linkages based on signaling from a controller.

12. The mount system of claim 11, wherein the mount system further includes:
a third linkage to connect the engine casing to the pylon in a second direction;
a fourth linkage to connect the engine casing to the pylon in a second direction;
a third pin to connect the first and second linkages to the engine casing;
a fourth pin to connect the first and second linkages to the pylon;
a second interface to engage with the third and fourth linkages, the second interface to at least one of rotate or slide; and
a second actuator to cause the interface to engage with the third and fourth linkages based on the signaling from the controller.

13. The mount system of claim 11, wherein the first and second linkages are a failsafe load path to a primary load path, the primary load path including at least the third linkage.

14. The mount system of claim 11, wherein the interface is tapered to fit into a slot in the first linkage.

15. The mount system of claim 11, wherein the first linkage is filled with a magnetorheological fluid.

16. The mount system of claim 15, further comprising a wire coil around the magnetorheological fluid.

17. The mount system of claim 11, wherein the actuator is at least one of a hydraulic actuator, a rack and pinion actuator, a piezoelectric actuator, or a shape memory alloy actuator.

18. The mount system of claim 11, wherein the interface is a dovetail-type sliding interface.

19. The mount system of claim 18, wherein the mount system further includes a dovetail-type receiving interface to movably retaining the dovetail-type sliding interface.

20. The mount system of claim 11, wherein the mount system further includes a locking pin, the locking pin positioned to reinforce the connection between the actuator and the interface.
